(19) United States
(12) Patent Application Publication
(10) Pub. No.: US 2026/0303198 A1
(43) Pub. Date: Oct. 1, 2026

(54) METHOD AND DEVICE FOR COMMUNICATION USING NETWORK-CONTROLLED REPEATER IN WIRELESS COMMUNICATION SYSTEM

(71) Applicant: Samsung Electronics Co., Ltd., Gyeonggi-do (KR)

(72) Inventors: Kyunggyu LEE, Gyeonggi-do (KR); Kyungjun CHOI, Gyeonggi-do (KR); Heedon GHA, Gyeonggi-do (KR); Yeongeun LIM, Gyeonggi-do (KR); Hyoungju JI, Gyeonggi-do (KR)

(21) Appl. No.: 19/695,721

(22) Filed: Jun. 2, 2026

Related U.S. Application Data
(62) Division of application No. 18/627,977, filed on Apr. 5, 2024, now abandoned.

(30) Foreign Application Priority Data
Apr. 5, 2023 (KR) 10-2023-0045046

(51) Int. Cl. H04B 7/155; H04W 72/0446

(52) U.S. Cl. CPC H04B 7/15542; H04W 72/0446

(57) ABSTRACT

In accordance with an aspect of the disclosure, a method and device for applying an aperiodic access link beam for each different subcarrier spacing (SCS) in a network-controlled repeater (NCR) processing signal relay between a base station and a UE in a wireless communication system is provided, the method performed by a network-controlled repeater (NCR) relaying a signal in a wireless communication system is provided, the method comprises identifying at least one reference slot to which the aperiodic access link beam is applied for each different subcarrier spacing (SCS), and applying the aperiodic access link beam based on the at least one reference slot and a slot offset.

### CROSS-REFERENCE TO RELATED APPLICATION(S)

This application is a Divisional Application of U.S. patent application Ser. No. 18/627,977, which was filed in the U.S. Patent and Trademark Office on Apr. 5, 2024, and is based on and claims priority under 35 U.S.C. § 119 to Korean Patent Application No. 10-2023-0045046, which was filed in the Korean Intellectual Property Office on Apr. 5, 2023, the entire disclosure of each of which is incorporated herein by reference.

### BACKGROUND

### 1. Field

The disclosure relates generally to a wireless communication system, and more particularly, to a communication method and device using a network-controlled repeater for relaying signals between a user equipment (UE) and a base station in a wireless communication system.

### 2. Description of Related Art

Fifth generation (5G) mobile communication technology defines a wide frequency band to enable fast transmission speed and new services and may be implemented in frequencies below 6 gigahertz (GHz) (‘sub 6 GHz’), such as 3.5 GHz, as well as in ultra-high frequency bands (‘above 6 GHz’), such as 28 GHz and 39 GHz referred to as millimeter wave (mmWave). Sixth generation (6G) mobile communication technology, referred to as a beyond 5G system, is considered to be implemented in terahertz (THz) bands (e.g., 95 GHz to 3 THz) to achieve a transmission speed 50 times faster than 5G mobile communication technology and ultra-low latency reduced by 1/10.

In the early stages of 5G mobile communication technology, standardization was conducted on beamforming and massive multiple input multiple output (MIMO) for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, layer 2 (L2) pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the VoNR, new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access channel (RACH) for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Development of such 5G mobile communication systems may be a basis for multi-antenna transmission technology, such as a new waveform for ensuring coverage in 6G mobile communication THz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of THz band signals, AI-based communication technology for realizing system optimization by embedding end-to-end AI supporting function and using satellite and AI from the design stage, and next-generation distributed computing technology for implementing services with complexity beyond the limit of the UE operation capability by way of ultrahigh performance communication and computing resources.

As such, there is a need in the art for a method and apparatus to provide more efficient resource management and control in the wireless communication system.

### SUMMARY

The disclosure has been made to address at least the above-mentioned problems and/or disadvantages and to provide at least the advantages described below.

Accordingly, an aspect of the disclosure is to provide a method and device for applying an aperiodic access link beam for each different SCS (SCS) in a network-controlled repeater (NCR) processing signal relay between a base station and a UE in a wireless communication system.

Another aspect of the disclosure is to provide a method and device for stably determining a reference slot on the time domain in an NCR when a base station indicates an access link beam having a different SCS.

In accordance with an aspect of the disclosure, a method performed by a network-controlled repeater (NCR) relaying a signal in a wireless communication system is provided, the method comprises identifying at least one reference slot to which the aperiodic access link beam is applied for each different subcarrier spacing (SCS), and applying the aperiodic access link beam based on the at least one reference slot and a slot offset.

In accordance with an aspect of the disclosure, a network-controlled repeater (NCR) relaying a signal in a wireless communication system is provided, the NCR comprises a transceiver, and a processor configured to identify at least one reference slot to which an aperiodic access link beam is applied for each different subcarrier spacing (SCS), and apply the aperiodic access link beam based on the at least one reference slot and a slot offset.

### BRIEF DESCRIPTION OF THE DRAWINGS

The foregoing and other aspects, features and advantages of certain embodiments of the present disclosure will become more apparent from the following description with reference to the accompanying drawings, in which:

FIG. 1 illustrates a transmission structure in the time-frequency domain in LTE, evolved universal terrestrial radio access (E-UTRA), LTE-advanced (LTE-A), or a similar wireless communication system according to an embodiment;

FIG. 2 illustrates a frame, subframe, and slot structure in 5G according to an embodiment;

FIG. 3 illustrates a BWP configuration in a wireless communication system according to an embodiment;

FIG. 4 illustrates a structure of a downlink control channel of a wireless communication system according to an embodiment;

FIG. 5 illustrates a structure of a downlink control channel of a wireless communication system according to an embodiment;

FIG. 6 illustrates an example of a time axis resource allocation of a physical downlink shared channel (PDSCH) in a wireless communication system according to an embodiment;

FIG. 7 illustrates an example of allocating a resource on a PDSCH time axis in a wireless communication system according to an embodiment;

FIG. 8 illustrates a semi-static HARQ-ACK codebook configuration method in an NR system according to an embodiment;

FIG. 9 illustrates a dynamic HARQ-ACK codebook configuration method in an NR system according to an embodiment;

FIG. 10 illustrates an example transmission/reception operation of an NCR when the NCR relays between a base station and a UE according to an embodiment;

FIG. 11 illustrates an example in which an NCR receives a beam indication for an access link from a base station according to an embodiment;

FIG. 12A illustrates an example in which an NCR receives an aperiodic access link beam indication from a base station according to an embodiment;

FIG. 12B illustrates an example in which an NCR applies an access link beam in a symbol section in a corresponding slot based on an aperiodic access link beam indication according to an embodiment;

FIG. 13 illustrates an example of an entire offset from a slot when an NCR receives an aperiodic access link beam indication from a base station to a slot when an access link beam is applied according to an embodiment;

FIG. 14 illustrates an example of an entire offset for each different SCS of an aperiodic access link beam indication that an NCR receives from a base station according to an embodiment;

FIG. 15 illustrates an example of ensuring a preparation time of an NCR for applying an access link beam in case 2 of FIG. 14 according to an embodiment;

FIG. 16 illustrates a method in which an NCR determines an entire offset of an access link beam in a wireless communication system according to an embodiment;

FIG. 17 illustrates an example of when an NCR uses the same maximum slot offset for slots using different SCSs according to an embodiment;

FIG. 18 illustrates an example in which different time resources of an NCR overlap in the same symbol according to an embodiment;

FIG. 19 illustrates a structure of a UE NCR in a wireless communication system according to an embodiment; and

FIG. 20 illustrates a structure of a base station in a wireless communication system according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

Similarly, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure, the same reference numeral denotes the same element throughout the specification.

As used herein, the term unit indicates a software element or a hardware element such as a field-programmable gate array (FPGA) or an application specific integrated circuit (ASIC). A unit plays a certain role. However, a unit is not limited to software or hardware and may be configured in a storage medium that may be addressed or may be configured to execute one or more processors. Accordingly, a unit includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the units may be combined into smaller numbers of components and ‘units’ or further separated into additional components and units. The components and units may be implemented to execute one or more CPUs in a device or secure multimedia card. A unit may include one or more processors.

As used herein, each of such expressions as A or B, at least one of A and B, at least one of A or B, A, B, or C, at least one of A, B, and C, and at least one of A, B, or C, may include all possible combinations of the items enumerated together in a corresponding one of the phrases. As used herein, such terms as 1st and 2nd, or first and second may be used to simply distinguish a corresponding component from another and do not limit the components in other aspect.

The terms used herein are defined considering the functions in the disclosure and may be replaced with other terms according to the intention or practice of the user or operator. Therefore, the terms should be defined based on the overall disclosure. Hereinafter, the base station may be an entity allocating resource to terminal and may be at least one of gNode B, eNode B, Node B, base station (BS), wireless access unit, base station controller, or node over network. The terminal may include UE (user equipment), MS (mobile station), cellular phone, smartphone, computer, or multimedia system capable of performing communication functions. The disclosure is not limited to the above examples. Described below is technology for receiving broadcast information from a base station by a UE in a wireless communication system. The disclosure relates to communication techniques for merging 5G communication systems with IoT technology to support a high data transmission rate in post-4th generation (4G) system and systems therefor. The disclosure can be applied to an intelligent service (for example, smart home, smart building, smart city, smart car or connected car, health care, digital education, retail, security and safety-related services, and the like) based on a 5G communication technology and an IoT-related technology.

Hereinafter, terms denoting broadcast information, control information, communication coverage, state or event variations, network entities, messages, or device components are provided solely for illustration purposes. The disclosure is not limited to the terms, and other terms equivalent in technical concept may also be used.

For ease of description, some of the terms and names defined in the 3rd generation partnership project long term evolution (3GPP LTE) standards may be used. However, the disclosure is not limited by such terms and names and may be likewise applicable to systems conforming to other standards.

Wireless communication systems evolve beyond voice-centered services to broadband wireless communication systems to provide high data rate and high-quality packet data services, such as 3rd generation partnership project (3GPP) high speed packet access (HSPA), long term evolution (LTE) or evolved universal terrestrial radio access (E-UTRA)), LTE-advanced (LTE-A), LTE-pro, 3GPP2 high rate packet data (HRPD), ultra mobile broadband (UMB), and institute of electrical and electronics engineers (IEEE) 802.16e communication standards.

As a representative example of such broadband wireless communication system, the LTE system adopts orthogonal frequency division multiplexing (OFDM) for downlink and single carrier frequency division multiple access (SC-FDMA) for uplink. scheme allocates and operates time-frequency resources carrying data or control information per user not to overlap, i.e., to maintain orthogonality, to thereby differentiate each user's data or control information.

Post-LTE communication systems, e.g., 5G communication systems, are required to freely reflect various needs of users and service providers and thus to support services that meet various requirements. Services considered for 5G communication systems include, e.g., increased mobile broadband (eMBB), massive machine type communication (MMTC), and ultra reliability low latency communication (URLLC).

According to an embodiment, eMBB aims to provide a further enhanced data transmission rate as compared with LTE, LTE-A, or LTE-pro. For example, eMBB for 5G communication systems needs to provide a peak data rate of 20 Gbps on download and a peak data rate of 10 Gbps on uplink in terms of one base station. The 5G communication system is also required to provide the increased user perceived data rate of the UE. To meet such requirements, transmit (TX)/receive (RX) techniques, as well as multiple input multiple output (MIMO), need to further be enhanced. The data transmission rate required for 5G communication systems may be met by using a broader frequency bandwidth than 20 Mhz in a frequency band ranging 3 Ghz to 6 Ghz or a frequency band of 6 Ghz or more instead of the 2 Ghz band currently adopted in LTE.

mMTC is also considered to support application services, such as internet of things (IoT) in the 5G communication system. To efficiently provide IoT, mMTC may be required to support massive UEs in the cell, enhance the coverage of the UE and the battery time, and reduce UE costs. IoT terminals are attached to various sensors or devices to provide communication functionality, and thus, it needs to support a number of UEs in each cell (e.g., 1,000,000 UEs/km²). Since mMTC-supportive UEs, by the nature of service, are highly likely to be located in shadow areas not covered by the cell, such as the underground of a building, it may require much broader coverage as compared with other services that the 5G communication system provides. mMTC-supportive UEs, due to the need for being low cost and difficulty in frequently exchanging batteries, may be required to have a very long battery life.

The URLLC, as a cellular-based wireless communication service used for a specific purpose (mission-critical), may be a service used for remote control for robots or machinery, industrial automation, unmanned aerial vehicles, remote health care, and emergency alerts and may be required to provide communication that provides ultra-low latency and ultra-high reliability. For example, URLLC-supportive services need to meet an air interface latency of less than 0.5 milliseconds simultaneously with a packet error rate of 10⁻⁵ or less. Thus, for URLLC-supportive services, the 5G communication system may be required to be designed to provide a shorter transmit time interval (TTI) than those for other services and allocate a broad resource in the frequency band. However, the aforementioned mMTC, URLLC, and eMBB are merely examples of different service types, and the service types to which the disclosure is applied are not limited to the above-described examples.

Services considered in the 5G communication system described above should be merged together based on one framework. In other words, for efficient resource management and control, it is preferable that the services are integrated into a single system and controlled and transmitted, rather than being independently operated.

Although LTE, LTE-A, LTE Pro, or NR systems are described herein, embodiments may also apply to other communication systems with a similar technical background or channel form. The embodiments may be modified in such a range as not to significantly depart from the scope of the disclosure under the determination by one of ordinary skill in the art and such modifications may be applicable to other communication systems.

### 5G System Frame Structure

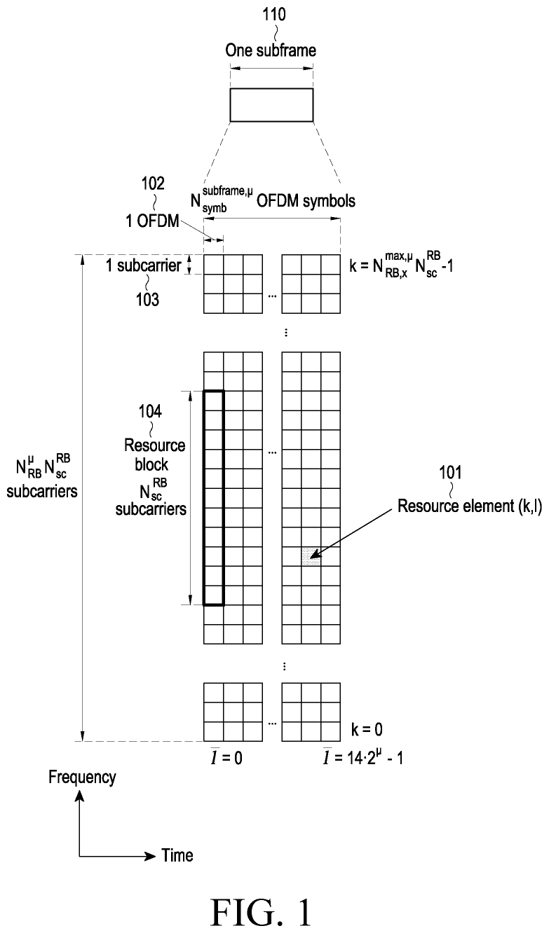

FIG. 1 illustrates a basic structure of a time-frequency resource in a wireless communication system according to an embodiment.

Referring to FIG. 1, the horizontal axis refers to the time domain, and the vertical axis refers to the frequency domain. A basic unit of a resource in the time and frequency domain is a resource element (RE) 101, which may be defined by one OFDM symbol 102 on the time axis, and by one subcarrier 103 on the frequency axis. In the frequency domain.

$${N}_{sc}^{RB}$$

(e.g., 12) consecutive REs may constitute one resource block (RB) 104. A plurality of OFDM symbols may constitute one subframe 110, and

$${N}_{symb}^{subframe , μ}$$

is the number of OFDM symbols per subframe 110 for SCS setting (μ).

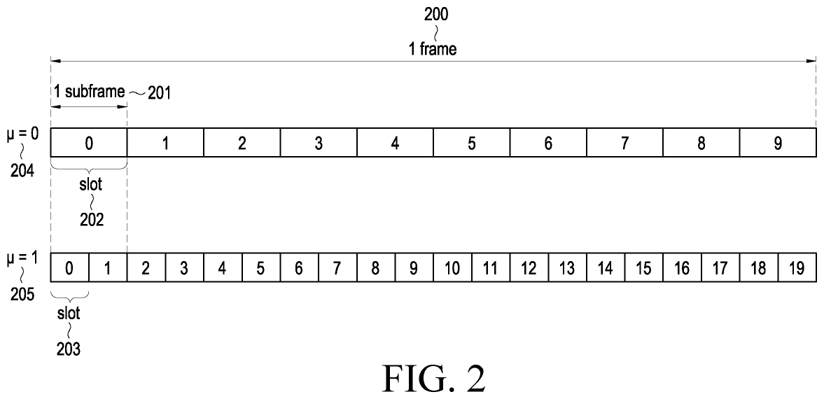

FIG. 2 illustrates a frame, a subframe, and a slot structure of a wireless communication system according to an embodiment.

Referring to FIG. 2, one frame 200 may include one or more subframes 201, and one subframe may include one or more slots 202. For example, one frame 200 may be defined as 10 ms. One subframe 201 may be defined as 1 ms, in which case one frame 2 may consist of a total of 10 subframes 201. One slot 202 or 203 may be defined as 14 OFDM symbols (that is, the number

$$( {N}_{symb}^{slot} )$$

of symbols per slot=14). One subframe 201 may be composed of one or more slots 202 and 203, and the number of slots 202 and 203 per subframe 201 may differ depending on μ (204 or 205), which is a set value for the SCS. In FIG. 2, the SCS setting value μ=0 (204) and an example in which the SCS setting value μ=1 (205). When μ=0 (204), one subframe 201 may consist of one slot 202, and when μ=1 (205), one subframe 201 may consist of two slots (203). In other words, according to the set SCS value μ, the number

$$( {N}_{slot}^{subframe , μ} )$$

of slots per subframe may vary, and accordingly, the number

$$( {N}_{slot}^{frame , μ} )$$

of slots per frame may differ. According to each SCS μ,

$${N}_{slot}^{subframe , μ} and {N}_{slot}^{frame , μ}$$

are defined as shown below in Table 1.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In NR, one component carrier (CC) or serving cell may be composed of up to 250 or more RBs. Therefore, if the UE always receives the entire serving cell bandwidth as does the LTE, the power consumption of the UE may be extreme. To address this issue, the base station may set one or more BWPs to allow the UE to change the reception region in the cell. In NR, the base station may configure an initial BWP, which is the bandwidth of a control resource set (CORESET) #0 (or common search space (CSS)), to the UE through a master information block (MIB). Thereafter, the base station may set the initial BWP (or first BWP) of the UE through radio resource control (RRC) signaling and provide at least one or more pieces of BWP configuration information that may be indicated via downlink control information (DCI) in the future. Thereafter, the base station may indicate what band is to be used by the UE by providing a BWP ID via DCI. When the UE fails to receive the DCI in the currently allocated BWP for a specific time or longer, the UE may return to a default BWP to attempt to receive the DCI.

### 5G BWP

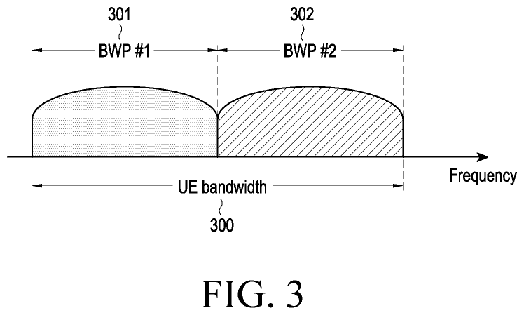

FIG. 3 illustrates an example of a BWP configuration in a wireless communication system according to an embodiment.

Referring to FIG. 3, a UE bandwidth 300 is configured to have two BWPs, e.g., BWP #1 301 and BWP #2 302. The base station may configure one or more BWPs in the UE and, for each BWP, information as shown below in Table 2 may be configured.

TABLE 2

| | |
|---|---|
| BWP ::= | SEQUENCE { |
| bwp-Id | BWP-Id, |

(identifier of bandwidth part)

| | |
|---|---|
| locationAndBandwidth | INTEGER (1..65536), |

(location of bandwidth part)

| | |
|---|---|
| subcarrierSpacing | ENUMERATED {n0, n1, n2, n3, n4, n5}, |
| cyclicPrefix | ENUMERATED { extended } |

}

In Table 2, locationAndBandwidth denotes the location and bandwidth in the frequency domain of the BWP, subcarrierSpacing denotes the SCS to be used in the BWP, and cyclicPrefix denotes whether the extended cyclic prefix (CP) is used for the BWP.

However, other various BWP-related parameters than the above-described configuration information may be configured in the UE. The above-described information may be delivered from the base station to the UE through higher layer signaling, e.g., RRC signaling. At least one of the one or more BWPs configured may be activated. Whether to activate the configured BWP may be transferred from the base station to the UE semi-statically through RRC signaling or dynamically through a MAC control element (CE) or DCI.

Prior to RRC connected, the UE may be configured with an initial BWP for initial access by the base station via an MIB. More specifically, the UE may receive configuration information for a search space and CORESET in which physical downlink control channel (PDCCH) may be transmitted to receive system information (remaining system information (RMSI) or system information block 1 (SIB1)) for initial access through the MIB in the initial access phase. Each of the control region and search space configured with the MIB may be regarded as identity (ID) 0.

The base station may provide the UE with configuration information, such as frequency allocation information, time allocation information, and numerology for control region #0, via the MIB. The base station may provide the UE with configuration information for occasion and monitoring period for control region #0, i.e., configuration information for search space #0, via the MIB. The UE may regard the frequency range set as control region #0 obtained from the MIB, as the initial BWP for initial access. In this case, the ID of the initial BWP may be regarded as 0.

The configuration of the BWP supported by the above-described next-generation mobile communication system (5G or NR system) may be used for various purposes.

For example, when the bandwidth supported by the UE is smaller than the system bandwidth, the bandwidth supported by the UE may be supported by configuring BWPs. For example, as the frequency position (configuration information 2) of the BWP in Table 2 is configured in the UE through configuration information 2, the UE may transmit and receive data in a specific frequency position within the system bandwidth.

As another example, to support different numerology, the base station may configure a plurality of BWPs in the UE. For example, to support data transmission/reception using an SCS of 15 kHz and a SCS of 30 kHz for some UE, the two BWPs may be configured to use the SCSs of 15 kHz and 30 kHz, respectively. The different BWPs may be frequency division multiplexed (FDM) and, when data is to be transmitted/received at a specific SCS, the BWP configured as the corresponding SCS may be activated.

As another example, to reduce power consumption of the UE, the base station may configure BWPs having different sizes of bandwidths in the UE. For example, when the UE supports a bandwidth exceeding a very large bandwidth, e.g., a bandwidth of 100 MHz, and transmits/receives data always using the bandwidth, significant power consumption may occur. In particular, it is very inefficient in terms of power consumption for the UE to monitor an unnecessary downlink control channel for a large bandwidth of 100 MHz when there is no traffic. Therefore, to reduce power consumption of the UE, the base station may configure a BWP of a relatively small bandwidth to the UE, e.g., a BWP of 20 Mhz, in the UE. When there is no traffic, the UE may perform a monitoring operation in the 20 MHz BWP, and when data is generated, the UE may transmit and receive data using a BWP of 100 Mhz according to an instruction from the base station.

In a method for configuring the above-described BWP, UEs before RRC connected may receive configuration information for an initial bandwidth via an MIB in the initial access phase. More specifically, the UE may be configured with a CORESET for the downlink control channel where the DCI scheduling the system information block (SIB) may be transmitted from the MIB of the physical broadcast channel (PBCH). The bandwidth of the configured by the MIB may be regarded as the initial BWP, and the UE may receive the PDSCH, which transmits the SIB, via the initial BWP. The initial BWP may be utilized for other system information (OSI), paging, and random access as well as for receiving SIB.

### SSB/PBCH

The SS/PBCH block may indicate a physical layer channel block composed of primary SS (PSS), secondary SS (SSS), and PBCH. More specifically, the SS/PBCH block may be defined as follows.

PSS serves as a reference for downlink time/frequency synchronization and may provide part of the information for a cell ID.
SSS serves as a reference for downlink time/frequency synchronization, and may provide the rest of the information for cell ID, which PSS does not provide. Additionally, it may serve as a reference signal for demodulation of PBCH.

PBCH may provide essential system information necessary for the UE to transmit and receive data channel and control channel. The essential system information may include search space-related control information indicating radio resource mapping information for a control channel and scheduling control information for a separate data channel for transmitting system information.

SS/PBCH block may be composed of a combination of PSS, SSS, and PBCH. One or more SS/PBCH blocks may be transmitted within 5 ms, and each transmitted SS/PBCH block may be distinguished with an index.

The UE may detect the PSS and SSS in the initial access phase and may decode the PBCH. The UE may obtain the MIB from the PBCH and be configured with control region #0 through the MIB. The UE may perform monitoring on control region #0, assuming that the selected SS/PBCH block and the demodulation reference signal (DMRS) transmitted in control region #0 are quasi-co-located (QCLed). The UE may receive system information as DCI transmitted in control region #0. The UE may obtain configuration information related to RACH required for initial access from the received system information. The UE may transmit the physical RACH (PRACH) to the base station considering the selected SS/PBCH index, and the base station receiving the PRACH may obtain information for the SS/PBCH block index selected by the UE. The base station may be aware what block among the SS/PBCH blocks has been used by the UE and of monitoring control region #0 corresponding to (or associated with) the SS/PBCH block selected by the UE.

### PDCCH: DCI

In the 5G or NR system, scheduling information for uplink data (or physical uplink shared channel (PUSCH) or downlink data (or PDSCH in the 5G system may be transmitted from the base station through DCI to the UE. The UE may monitor the DCI format for fallback and the DCI format for non-fallback for PUSCH or PDSCH. The fallback DCI format may be composed of fixed fields predefined between the base station and the UE, and the non-fallback DCI format may include configurable fields.

DCI may be transmitted through the PDCCH, via channel coding and modulation. A cyclic redundancy check (CRC) is added to the DCI message payload, and the CRC is scrambled with the radio network temporary identifier (RNTI) that is the identity of the UE. Different RNTIs may be used for scrambling the CRC attached to the payload of the DCI message based on the DCI message, e.g., UE-specific data transmission, power control command, or random access response. In other words, the RNTI is not explicitly transmitted, but the RNTI is included in the CRC calculation process and transmitted. If the UE receives the DCI message transmitted on the PDCCH, the UE may identify the CRC using the allocated RNTI. If the result of identifying the CRC is correct, the UE may know that the message is transmitted to the UE.

For example, DCI scheduling a PDSCH for system information (SI) may be scrambled to SI-RNTI. The DCI scheduling a PDSCH for a random access response (RAR) message may be scrambled to RA-RNTI. DCI scheduling a PDSCH for a paging message may be scrambled with P-RNTI. The DCI providing a slot format indicator (SFI) may be scrambled to SFI-RNTI. The DCI providing transmit power control (TPC) may be scrambled to TPC-RNTI. The DCI for scheduling a UE-specific PDSCH or PUSCH may be scrambled with cell RNTI (C-RNTI).

DCI format 0_0 may be used as fallback DCI for scheduling the PUSCH, and in this case, CRC may be scrambled to C-RNTI. DCI format 0_0 in which CRC is scrambled to C-RNTI may include information as shown below in Table 3.

```
TABLE 3
  Identifier for DCI formats - [1] bit
  $\begin{matrix}Frequency domain resource assignment - \\ [ ⌈ {log}_{2} ( {N}_{RB}^{UL , BWP} ( {N}_{RB}^{UL , BWP} + 1 ) / 2 ) ⌉ ] bits\end{matrix}$
  Time domain resource assignment - X bits
  Frequency hopping flag - 1 bit.
  Modulation and coding scheme - 5 bits
  New data indicator - 1 bit
  Redundancy version - 2 bits
  HARQ process number - 4 bits
  TPC command for scheduled PUSCH (transmit power control
command for scheduled PUSCH - [2] bits
  UL/SUL indicator (UL/SUL(supplementary UL) indicator) - 0 or 1 bit
```

DCI format 0_1 may be used as non-fallback DCI for scheduling the PUSCH, and in this case, CRC may be scrambled to C-RNTI. DCI format 0_1 in which CRC is scrambled to C-RNTI may include information as shown below in Table 4.

```
TABLE 4
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
    $For resource allocation type 0 , ⌈ {N}_{RB}^{UL , BWP} / P ⌉ bits$
    $For resource allocation type 1 , ⌈ {log}_{2} ( {N}_{RB}^{UL , BWP} ( {N}_{RB}^{UL , BWP} + 1 ) / 2 ) ⌉ bits$
  Time domain resource assignment -1, 2, 3, or 4 bits
  VRB(virtual resource block)-to-PRB(physical resource block) mapping - 0 or 1 bit, only for resource
allocation type 1.
      0 bit if only resource allocation type 0 is configured;
      1 bit otherwise.
  Frequency hopping flag - 0 or 1 bit, only for resource allocation type 1.
      0 bit if only resource allocation type 0 is configured;
      1 bit otherwise.
  Modulation and coding scheme - 5 bits
  New data indicator - 1 bit
  Redundancy version - 2 bits
  HARQ process number - 4 bits
  1st downlink assignment index - 1 or 2 bits
      1 bit for semi-static HARQ-ACK codebook;
      2 bits for dynamic HARQ-ACK codebook with single HARQ-ACK codebook.
  2nd downlink assignment index - 0 or 2 bits
      2 bits for dynamic HARQ-ACK codebook with two HARQ-ACK sub-codebooks;
      0 bit otherwise.
  TPC command for scheduled PUSCH - 2 bits
  $SRS resource indicator - ⌈ {log}_{2} ( {\sum }_{k = 1}^{{L}_{max} Σ} ( \begin{matrix}{N}_{SRS} \\ k\end{matrix} ) ) ⌉ or ⌈ {log}_{2} ( {N}_{SRS} ) ⌉ bits$
      $⌈ {log}_{2} ( {\sum }_{k = 1}^{{L}_{max} Σ} ( \begin{matrix}{N}_{SRS} \\ k\end{matrix} ) ) ⌉ bits for non - codebook based PUSCH transmission ;$
      ┌log₂(N_{SRS})┐ bits for codebook based PUSCH transmission.
  Precoding information and number of layers -up to 6 bits
  Antenna ports - up to 5 bits
  SRS request - 2 bits
  CSI(channel state information) request - 0, 1, 2, 3, 4, 5, or 6 bits
  CBG(code block group) transmission information - 0, 2, 4, 6, or 8 bits
  PTRS(phase tracking reference signal)-DMRS(demodulation reference signal) association - 0 or 2
bits.
  beta_offset indicator - 0 or 2 bits
      DMRS sequence initialization - 0 or 1 bit
```

DCI format 1_0 may be used as fallback DCI for scheduling a PDSCH. In this case, CRC may be scrambled to C-RNTI. DCI format 1_0 in which CRC is scrambled to C-RNTI may include information as shown below in Table 5.

TABLE 5

Identifier for DCI formats - [1] bit
$\begin{matrix}Frequency domain resource assignment - \\ [ ⌈ {log}_{2} ( {N}_{RB}^{DL , BWP} ( {N}_{RB}^{DL , BWP} + 1 ) / 2 ) ⌉ ] bits\end{matrix}$
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
PUCCH resource indicator - 3 bits
PDSCH-to-HARQ feedback timing indicator - [3] bits

Alternatively, DCI format 1_0 may be used as scheduling the PDSCH for the RAR message, and CRC may be scrambled to RA-RNTI. DCI format 1_0 in which CRC is scrambled to C-RNTI may include the information shown below in Table 6.

TABLE 6

$\begin{matrix}Frequency domain resource assignment - \\ ⌈ {log}_{2} ( {N}_{RB}^{DL , BWP} ( {N}_{RB}^{DL , BWP} + 1 ) / 2 ) ⌉ ] bits\end{matrix}$
Time domain resource assignment - 4 bits
VRB-to-PRB mapping - 1 bit
Modulation and coding scheme - 5 bits
TB scaling - 2 bits
Reserved bits - 16 bits

DCI format 1_1 may be used as non-fallback DCI for scheduling a PDSCH, and in this case, CRC may be scrambled to C-RNTI. DCI format 1_1 in which CRC is scrambled to C-RNTI may include information as shown below in Table 7.

```
TABLE 7
  Carrier indicator - 0 or 3 bits
  Identifier for DCI formats - [1] bits
  Bandwidth part indicator - 0, 1 or 2 bits
  Frequency domain resource assignment
    $For resource allocation type 0 , ⌈ {N}_{RB}^{UL , BWP} / P ⌉ bits$
    $For resource allocation type 1 , ⌈ {log}_{2} ( {N}_{RB}^{UL , BWP} ( {N}_{RB}^{UL , BWP} + 1 ) / 2 ) ⌉$
    bits
  Time domain resource assignment -1, 2, 3, or 4 bits
  VRB-to-PRB mapping - 0 or 1 bit, only for resource allocation
  type 1.
    0 bit if only resource allocation type 0 is configured;
    1 bit otherwise.
  PRB(physical resource block) bundling size indicator - 0 or 1 bit
  Rate matching indicator - 0, 1, or 2 bits
  ZP(zero power) CSI-RS trigger - 0, 1, or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication - 0 or 3 bits
  SRS request - 2 bits
  CBG(code block group) transmission information - 0, 2, 4, 6, or 8 bits
  CBG flushing out information - 0 or 1 bit
  DMRS sequence initialization - 1 bit
```

### Regarding PDCCH, PDSCH QCL Rule

When the UE operates in carrier aggregation (CA) in a band or a single cell, and a plurality of control resource sets present in the BWP activated in a single cell or a plurality of cells are equal to each other or overlap each other over time with the same or different QCL-TypeD characteristics in a specific PDCCH monitoring period, the UE may select a specific control resource set according to the QCL prioritization operation and monitor control resource sets having the same QCL-TypeD characteristics as those of the corresponding control resource set. In other words, when a plurality of control resource sets overlaps over time, only one QCL-TypeD characteristic may be received. In this case, the criteria for determining the QCL priority may be as follows.

Criterion 1. A control resource set connected to the CSS having the lowest index, in the cell corresponding to the lowest index among cells including the CSS.

Criterion 2. A control resource set connected to the UE-specific search space having the lowest index in the cell corresponding to the lowest index among cells including the UE-specific search space;

When the above criteria are not met, the following criteria apply. For example, when control resource sets overlap over time in a specific PDCCH monitoring period, if all control resource sets are not connected to the CSS but are connected to the UE specific search space, i.e., if criterion 1 is not met, the UE may apply criterion 2 while omitting criterion 1.

When the UE selects the control resource set based on the above-described criteria, the UE may additionally consider two matters regarding the QCL information set in the control resource set as follows. First, when control resource set 1 has CSI-RS 1 as a reference signal in which control resource set 1 has the QCL-TypeD relationship, the reference signal in which CSI-RS 1 has the QCL-TypeD relationship is SSB1, and the reference signal in which another control resource set 2 has the QCL-TypeD relationship is SSB1, the UE may consider that the two control resource sets 1 and 2 have different QCL-TypeD characteristics. Second, when the UE has CSI-RS 1 configured in cell 1, as a reference signal in which control resource set 1 has the QCL-TypeD relationship, the reference signal in which CSI-RS 1 has the QCL-TypeD relationship is SSB1, and, the control resource set 2 has CSI-RS 2 configured in cell 2, as a reference signal in which control resource set 2 has the QCL-TypeD relationship, and the reference signal in which CSI-RS 2 has the QCL-TypeD relationship is SSB1, the UE may consider that the two control resource sets have the same QCL-TypeD characteristics.

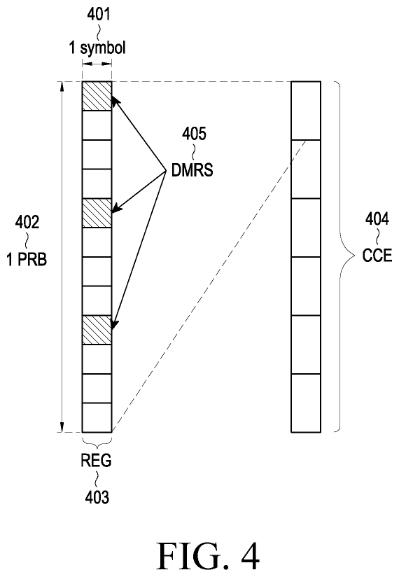

FIG. 4 illustrates a structure of a downlink control channel of a wireless communication system according to an embodiment. That is, FIG. 4 relates to a basic unit of time and frequency resource constituting a download control channel available in 5G.

Referring to FIG. 4, the basic unit of time and frequency resource constituting the control channel may be defined as an RE group (REG) 403. The REG 403 may be defined with one OFDM symbol 401 on the time axis and one physical RB (PRB) 402, i.e., 12 subcarriers. The base station may configure a downlink control channel allocation unit by concatenating REGs 403.

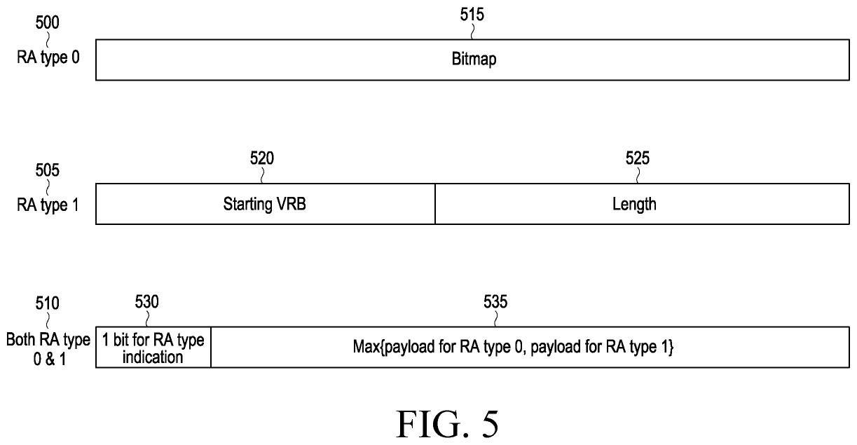

If the basic unit for allocation of a downlink control channel in 5G is a control channel element (CCE) 404, one CCE 404 may be composed of multiple REGs 403. For example, the REG 403 shown in FIG. 5 may be constituted of 12 REs, and if one CCE 404 is constituted of six REGs 503, one CCE 404 may be constituted of 72 REs. When the download control region is set, the region may be constituted of multiple CCEs 404, and a particular download control channel may be mapped to one or more CCEs 404 according to the aggregation level (AL) in the control region and be transmitted. The CCEs 404 in the control region are distinguished with numbers, and in this case, the numbers of the CCEs 404 may be assigned according to a logical mapping scheme.

The basic unit, i.e., the REG 403, of the download control channel shown in FIG. 4 may contain REs to which the DCI is mapped and the region to which the DMRS 405, a reference signal for decoding the REs, is mapped. As illustrated, three DMRSs 405 may be transmitted in one REG 403. The number of CCEs necessary to transmit a PDCCH may be, e.g., 1, 2, 4, 8, or 16 depending on the AL, and different numbers of CCEs may be used to implement link adaptation of downlink control channel. For example, if AL=L, one downlink control channel may be transmitted via L CCEs.

The UE needs to detect a signal while being unaware of information for downlink control channel and, for blind decoding, a search space is defined which indicates a set of CCEs. The search space is a set of downlink control channel candidates constituted of CCEs that the UE should attempt to decode on a given AL. Since there are several ALs for creating a bundle of 1, 2, 4, 8, or 16 CCEs, the UE may have a plurality of search spaces. A search space set (Set) may be defined as a set of search spaces at all set ALs.

Search spaces may be classified into a CSS and a UE-specific search space. A predetermined group of UEs or all the UEs may search for the CSS of the PDCCH to receive cell-common control information, e.g., paging message, or dynamic scheduling for system information.

For example, the UE may receive PDSCH scheduling allocation information for transmitting an SIB containing, e.g., cell service provider information by investigating the CSS of the PDCCH. In the case of the CSS, since a certain group of UEs or all the UEs need receive the PDCCH, the CSS may be defined as a set of CCEs previously agreed on. Meanwhile, the UE may receive scheduling allocation information for the UE-specific PDSCH or PUSCH by inspecting the UE-specific search space of PDCCH. The UE-specific search space may be UE-specifically defined with a function of various system parameters and the identity of the UE.

In 5G, the parameters for the search space for the PDCCH may be configured in the UE by the base station through higher layer signaling (e.g., SIB, MIB, or RRC signaling). For example, the base station may configure the UE with, e.g., the number of PDCCH candidates at each AL=L, monitoring period for search space, monitoring occasion of symbol unit in slot for search space, search space type (CSS or UE-specific search space), combination of RNTI and DCI format to be monitored in the search space, and control region index to be monitored in the search space. For example, the above-described configuration may include information as shown below in Table 8.

TABLE 8

| | |
|---|---|
| SearchSpace ::= | SEQUENCE { |

```
  -- Identity of the search space. SearchSpaceId = 0 identifies the
    SearchSpace configured via PBCH (MIB) or
    ServingCellConfigCommon.
```

| | |
|---|---|
| searchSpaceId | SearchSpaceId, |
| controlResourceSetId | ControlResourceSetId, |
| monitoringSlotPeriodicityAndOffset | CHOICE { |

(monitoring slot level period)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration(monitoring length) | INTEGER |
| | (2..2559) |
| monitoringSymbolsWithinSlot | BIT STRING (SIZE |
| | (14)) |
| | OPTIONAL, |
| nrofCandidates | SEQUENCE { |

(number of PDCCH candidates at each aggregation level)

| | |
|---|---|
| aggregationLevel1 | ENUMERATED {n0, |

n1, n2, n3, n4, n5, n6, n8},

| | |
|---|---|
| aggregationLevel2 | ENUMERATED {n0, |

n1, n2, n3, n4, n5, n6, n8},

| | |
|---|---|
| aggregationLevel4 | ENUMERATED {n0, |

n1, n2, n3, n4, n5, n6, n8},

| | |
|---|---|
| aggregationLevel8 | ENUMERATED {n0, |

n1, n2, n3, n4, n5, n6, n8},

| | |
|---|---|
| aggregationLevel16 | ENUMERATED {n0, |

```
        n1, n2, n3, n4, n5, n6, n8}
      },
```

| | |
|---|---|
| searchSpaceType | CHOICE { |

```
        -- Configures this search space as common search space (CSS)
        and DCI formats to monitor.
```

| | |
|---|---|
| common | SEQUENCE { |

}

| | |
|---|---|
| ue-Specific | SEQUENCE { |

```
          -- Indicates whether the UE monitors in this USS for DCI
        formats 0-0 and 1-0 or for formats 0-1 and 1-1.
```

| | |
|---|---|
| formats | ENUMERATED |

```
        {formats0-0-And-1- 0, formats0-1-And-1-1},
          ...
      }
```

Based on the configuration information, the base station may configure one or more search space sets to the terminal. The base station may configure the UE with search space set 1 and search space set 2 and configure it to monitor DCI format A, scrambled to X-RNTI in search space set 1, in the CSS and to monitor DCI format B, scrambled to Y-RNTI in search space set 2, in the UE-specific search space.

According to the above-described configuration information, one or more search space sets may be present in the CSS or the UE-specific search space. For example, search space set #1 and search space set #2 may be configured as the CSS, and search space set #3 and search space set #4 may be configured as the UE-specific search space.

The CSS may be classified as a specific-type search space set according to the purpose. The RNTI to be monitored may be different for each determined search space set type. For example, the CSS type, purpose, and RNTI to be monitored may be classified as shown below in Table 9.

TABLE 9

| search | | |
|---|---|---|
| space type | purpose | RNTI |
| Type0 CSS | PDCCH transmission for SIB | SI-RNTI |
| | schedule | |
| Type0A CSS | PDCCH transmission for | SI-RNTI |
| | scheduling other SIs (e.g., SIB2) | |
| | than SIB1 | |
| Type1 CSS | PDCCH transmission for RAR | RA-RNTI, |
| | scheduling, Msg3 retransmission | TC-RNTI |
| | scheduling, and Msg4 scheduling | |
| Type2 CSS | paging | P-RNTI |
| Type3 CSS | group control information | INT-RNTI, |
| | transmission | SFI-RNTI, |
| | | TPC-PUSCH-RNTI, |
| | | TPC-PUCCH-RNTI, |
| | | TPC-SRS-RNTI |
| | For PCell, PDCCH transmission | C-RNTI, |
| | for data scheduling | MCS-C-RNTI, |
| | | CS-RNTI |

In the CSS, a combination of DCI format and RNTI as follows may be monitored, but the disclosure is not limited to the examples described below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, a combination of DCI format and RNTI as follows may be monitored. Of course, it is not limited to the examples described below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may be defined and used as follows.
C-RNTI (Cell RNTI): for scheduling UE-specific PDSCH
Temporary cell RNTI (TC-RNTI): for scheduling UE-specific PDSCH
Configured scheduling RNTI (CS-RNTI): for scheduling semi-statically configured UE-specific PDSCH
Random access RNTI (RA-RNTI): for scheduling the PDSCH in the random access phase
Paging RNTI (P-RNTI): for scheduling the PDSCH where paging is transmitted
System information RNTI (SI-RNTI): for scheduling the PDSCH where system information is transmitted
Interruption RNTI (INT-RNTI): for indicating whether to puncture PDSCH
Transmit power control for PUSCH RNTI (TPC-PUSCH-RNTI): for indicating power control command for PUSCH
Transmit power control for PUCCH RNTI (TPC-PUCCH-RNTI): for indicating power control command for PUCCH
Transmit power control for SRS RNTI (TPC-SRS-RNTI): for indicating power control command for SRS

The above-described DCI formats may be defined as shown below in Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, a plurality of search space sets may be configured with different parameters (e.g., the parameters of Table 8). Therefore, the set of search spaces monitored by the UE at each point in time may vary. For example, when search space set #1 is set at the X-slot period, search space set #2 is set at the Y-slot period, and X differs from Y, the UE may monitor both search space set #1 and search space set #2 in a specific slot and monitor either search space set #1 or search space set #2 in a specific slot.

When a plurality of search space sets is configured to the UE, the following conditions may be considered to determine the search space sets that should be monitored by the UE.

### Condition 1: Limit to Maximum Number of Pdcch Candidate Groups

The number of PDCCH candidates that may be monitored per slot may not exceed Mu. Mu may be defined as the maximum number of PDCCH candidates per slot in the cell set as SCS 15.24 kHz and may be defined as shown below in Table 11.

TABLE 11

| | Maximum number of PDCCH candidates |
|---|---|
| μ | per slot and per serving cell (M^{μ}) |
| 0 | 44 |
| 1 | 36 |
| 2 | 22 |
| 3 | 20 |

### Condition 2: Limit to Maximum Number of CCEs

The number of CCEs constituting the entire search space per slot (where, the entire search space may indicate the entire CCE set corresponding to a union area of a plurality of search space sets) may not exceed C^{μ}. C^{μ} may be defined as the maximum number of CCEs per slot in the cell set as SCS 15·2^{μ} kHz, and may be defined as shown below in Table 12.

TABLE 12

| | Maximum number of CCEs per |
|---|---|
| μ | slot and per serving cell (C^{μ}) |
| 0 | 56 |
| 1 | 56 |
| 2 | 48 |
| 3 | 32 |

For convenience of description, a situation in which both conditions 1 and 2 above are met at a specific point in time may be defined as condition A. Accordingly, not meeting condition A may indicate not meeting at least one of conditions 1 and 2 above.

According to the configuration of search space sets by the base station, an occasion in which condition A is not met may occur at a specific point in time. If condition A is not met at a specific point in time, the UE may select only some of search space sets configured to meet condition A at that point in time to perform monitoring, and the base station may transmit the PDCCH through the selected search space set.

As a method for selecting some search spaces from the entire configured search space set, the following method may be followed.

### Method 1

When condition A for PDCCH is not met at a specific point in time (slot), the UE (or the base station) may select the search space set whose search space type is set as CSS among the search space sets present at the corresponding time point preferentially over the search space set which is set as UE-specific search space.

When all of the search space sets set as CSS are selected (i.e., when condition A is met even after all the search spaces set as CSS are selected), the UE (or base station) may select the search space sets set as UE-specific search space. In this case, when there is a plurality of search space sets set as UE-specific search space, the search space set having a lower search space set index may have higher priority. Considering priority, the UE or the base station may select UE-specific search space sets within a range where condition A is met.

Methods for allocating time and frequency resources for data transmission in NR are described below.

In NR, the following detailed frequency domain resource allocation (FD-RA) methods may be provided in addition to the frequency-domain resource candidate allocation through BWP indication.

FIG. 5 illustrates an example of frequency-domain resource allocation of a PDSCH in a wireless communication system according to an embodiment.

FIG. 5 illustrates three frequency domain resource allocation methods of type 0 500, type 1 505, and dynamic switch 510 configurable through higher layer in NR.

Referring to FIG. 5, if the UE is configured to use only resource type 0 through higher layer signaling (500), some DCI for allocating a PDSCH to the UE has a bitmap 515 composed of NRBG bits. The conditions for this are described below. In this case, NRBG indicates the number of RB groups (RBGs) determined as shown below in Table 13 according to the BWP size allocated by the BWP indicator and the higher layer parameter rbg-Size, and data is transmitted in the RBG in which is expressed as 1 by the bitmap.

TABLE 13

| BWP Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

If the UE is configured to use only resource type 1 through higher layer signaling (505), some DCIs that allocate a PDSCH to the corresponding UE has frequency axis resource allocation information composed of

$$⌈ {log}_{2} ( \frac{{N}_{RB}^{DLBWP} ( {N}_{RB}^{DLBWP} + 1 )}{2} ) ⌉$$

bits. The conditions for this are described below. Accordingly, the base station may set the starting virtual RB (VRB) 520 and the length 525 of the frequency axis resources contiguously allocated therefrom.

If the UE is configured to use both resource type 0 and resource type 1 through higher layer signaling (510), some DCIs that allocate a PDSCH to the UE have frequency axis resource allocation information composed of bits of the larger (535) of the payload 515 for setting resource type 0 and the payloads 520 and 525 for setting resource type 1. The conditions for this are described below. In this case, one bit may be added to the foremost part (e.g., a most significant bit (MSB)), of the frequency axis resource allocation information in the DCI. When the corresponding bit is 0, this may indicate that resource type 0 is used, whereas when the corresponding bit is 1, this may indicate that resource type 1 is used.

The base station may configure the UE with a table for time domain resource allocation information for a PDSCH and a PUSCH via higher layer signaling (e.g., RRC signaling). For PDSCH, a table including up to maxNrofDL-Allocations=16 entries may be configured and, for PUSCH, a table including up to maxNrofUL-Allocations=16 entries may be configured. The time domain resource allocation information may include, e.g., PDCCH-to-PDSCH slot timing (which is designated K0 and corresponds to the time interval between the time of reception of the PDCCH and the time of transmission of the PDSCH scheduled by the received PDCCH) or PDCCH-to-PUSCH slot timing (which is designated K2 and corresponds to the time interval between the time of PDCCH and the time of transmission of the PUSCH scheduled by the received PDCCH), information for the position and length of the start symbol where the PDSCH or PUSCH is scheduled in the slot, and the mapping type of PDSCH or PUSCH. For example, information as shown below in Table 14 or Table 15 may be provided from the base station to the UE.

TABLE 14
PDSCH-TimeDomainResourceAllocationList information element

```
PDSCH-TimeDomainResourceAllocationList ::= SEQUENCE
(SIZE(1..maxNrofDL- Allocations)) OF
PDSCH-TimeDomainResourceAllocation
PDSCH-TimeDomainResourceAllocation ::= SEQUENCE {
  k0 INTEGER(0..32)
OPTIONAL, -- Need S
  mappingType ENUMERATED {typeA, typeB},
  startSymbolAndLength INTEGER (0..127)
}
```

TABLE 15
PUSCH-TimeDomainResourceAllocationList information element

```
PUSCH-TimeDomainResourceAllocationList ::= SEQUENCE
(SIZE(1..maxNrofUL- Allocations)) OF
PUSCH-TimeDomainResourceAllocation
PUSCH-TimeDomainResourceAllocation ::= SEQUENCE {
  k2 INTEGER(0..32)
OPTIONAL, -- Need S
  mappingType ENUMERATED {typeA, typeB},
  startSymbolAndLength INTEGER (0..127)
}
```

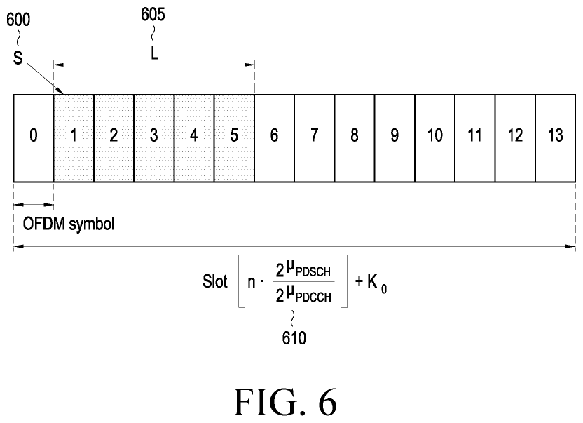

The base station may provide the UE with one of the entries in the table for the time domain resource allocation information via L1 signaling (e.g., DCI) (e.g., it may be indicated with the ‘time domain resource allocation’ field in the DCI). The UE may obtain time domain resource allocation information for the PDSCH or PUSCH based on the DCI received from the base station. FIG. 6 illustrates an example of a time axis resource allocation of a PDSCH in a wireless communication system according to an embodiment.

Referring to FIG. 6, the base station may indicate the position of the PDSCH resource on the time axis according to the SCS μ_{PDSCH}, μ_{PDCCH} of the data channel and the control channel configured using the higher layer, slot offset (K₀), and the OFDM symbol start position 600 and length 605 in one slot 610 dynamically indicated via DCI.

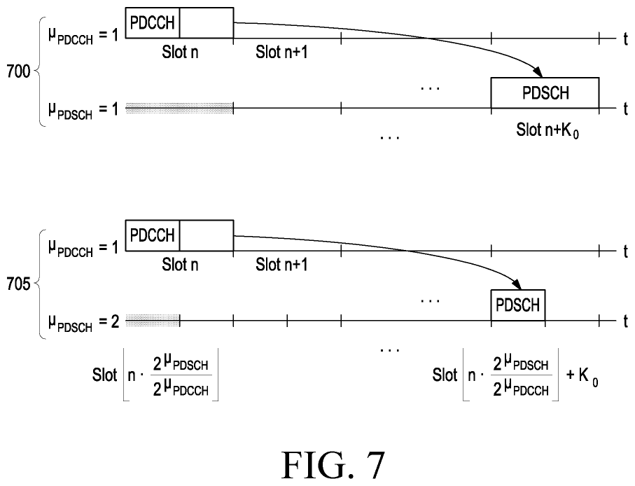

FIG. 7 illustrates an example of allocating a resource on a time axis according to SCSs of a data channel and a control channel in a wireless communication system according to an embodiment.

Referring to FIG. 7, when the SCSs of the data channel and the control channel are the same (700, μ_{PDSCH}=μ_{PDCCH}), the slot numbers for data and control are the same, so that the base station and the UE may be aware of generation of a scheduling offset according to a predetermined slot offset K0. In contrast, when the SCSs of the data channel and the control channel are different from each other (705, μ_{PDSCH}=≠_{PDCCH}), the slot numbers for data and control are different so that the base station and the UE may be aware of generation of a scheduling offset according to a predetermined slot offset K0 with respect to the SCS of the PDCCH.

### QCL, TCI State

In the wireless communication system, one or more different antenna ports (which may be replaced with one or more channels, signals, or combinations thereof, but are collectively referred to as different antenna ports for convenience of description) may be associated with each other through quasi co-location (QCL) configuration as shown below in Table 16.

The TCI state is for announcing the QCL relationship between the PDCCH (or PDCCH DMRS) and another RS or between channels. When some reference antenna port A (reference RS #A) and another target antenna port B (target RS #B) are QCLed with each other, this indicates that the UE is allowed to apply all or some of the large-scale channel parameters estimated in antenna port A to channel measurement from antenna port B. QCL may require associating different parameters depending on contexts, such as time tracking influenced by average delay and delay spread, frequency tracking influenced by Doppler shift and Doppler spread, radio resource management (RRM) influenced by average gain, and beam management (BM) influenced by spatial parameter. Accordingly, NR supports four types of QCL relationships as shown below in Table 16.

TABLE 16

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

Spatial RX parameter may collectively refer to all or some of various parameters, such as Angle of arrival (AoA), Power Angular Spectrum (PAS) of AoA, Angle of departure (AoD), PAS of AoD, transmit/receive channel correlation, transmit/receive beamforming, spatial channel correlation.

The QCL relationship may be configured to the UE through the RRC parameter TCI-State and QCL-Info as shown below in Table 17. Referring to Table 17, the base station may configure the UE with one or more TCI states, indicating up to two QCL relationships (qcl-Type1 and qcl-Type2) for the RS referencing the ID of the TCI state, i.e., the target RS. In this case, the QCL information (QCL-Info) included in each TCI state includes the serving cell index and BWP index of the reference RS indicated by the QCL information, type and ID of the reference RS, and the QCL type as shown above in Table 16.

TABLE 17

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS)
referring to corresponding TCI state ID)

| | | |
|---|---|---|
| qcl-Type2 | QCL-Info | OPTIONAL, |
| | | -- Need R |

```
  (QCL information of second reference RS of RS (target RS)
referencing corresponding TCI state ID)
  ...
}
```

| QCL-Info ::= | SEQUENCE { | |
|---|---|---|
| cell | ServCellIndex | OPTIONAL, |
| | | -- Need R |

```
  (serving cell index of reference RS indicated by
  corresponding QCL information)
```

| | | |
|---|---|---|
| bwp-Id | BWP-Id | OPTIONAL, |
| | | -- Cond |

```
CSI-RS-Indicated
  (BWP index of reference RS indicated by corresponding
  QCL information)
```

| | |
|---|---|
| referenceSignal | CHOICE { |
| csi-rs | NZP-CSI-RS-ResourceId, |
| ssb | SSB-Index |

```
    (either CSI-RSI ID or SSB ID indicated by corresponding
    QCL information)
  },
```

| | |
|---|---|
| qcl-Type | ENUMERATED {typeA, typeB, typeC, typeD}, |

...
}

### HARQ-ACK Feedback Transmission Method and Device

The NR system adopts hybrid automatic repeat request (HARQ) scheme that re-transmits corresponding data through the physical layer in case decoding fails at the initial stage of transmission. By the HARQ scheme, if the receiver fails to precisely decode data, the receiver transmits information (negative acknowledgement (NACK)) indicating the decoding failure to the transmitter so that the transmitter may re-transmit the corresponding data through the physical layer. The receiver raises the data reception capability by combining the data re-transmitted by the transmitter with the data for which decoding has previously failed. When the receiver precisely decodes data, the receiver may transmit information (acknowledgment (ACK)) indicating decoding succeeds to the transmitter so that the transmitter may transmit new data.

A method for configuring HARQ-ACK feedback bits when the UE transmits multiple HARQ-ACKs within one slot on the uplink, a method for configuring HARQ-ACK feedback bits is now described.

In NR, the base station may configure one or more CCs to the UE for downlink transmission. Each CC may have downlink transmission and uplink transmission slots and symbols configured therein. When a PDSCH, which is downlink data, is scheduled, at least one of the slot timing information to which the PDSCH is mapped in a specific bit field of the DCI, start symbol position to which the PDSCH is mapped in the corresponding slot, and information about the number of symbols to which the PDSCH is mapped may be transferred. For example, when DCI is transferred and PDSCH is scheduled in slot n, if K0 which is slot timing information where the PDSCH is transferred indicates 0, and the start symbol position is 0, and the symbol length is 7, the corresponding PDSCH is mapped to seven symbols starting from symbol 0, of slot n and is transmitted. K1 slots after the PDSCH which is a downlink data signal is transmitted, HARQ-ACK feedback is transferred from the UE to the base station. K1 information which is timing information where HARQ-ACK is transmitted is transferred in the DCI, and a set of possible candidates of the K1 value may be transferred by higher signaling, and one of them may be determined in the DCI.

When the UE is configured with semi-static HARQ-ACK codebook, the UE may determine a table including K0, start symbol information, number of symbols, or length information which are slot information where the PDSCH is mapped and feedback bits (or HARQ-ACK codebook size) that are supposed to be transmitted by the K1 candidate values which are HARQ-ACK feedback timing information for the PDSCH. The table including the slot information where the PDSCH is mapped, start symbol information, number of symbols, or length information may vary depending on the default value or may also be configured to the UE by the base station.

When the UE is configured with the dynamic HARQ-ACK codebook, the UE may determine the HARQ-ACK feedback bit (or HARQ-ACK codebook size) that should be transmitted by the UE downlink assignment indicator (DAI) included in the DCI in the slot where HARQ-ACK information is transmitted by K0 which is slot information where the PDSCH is mapped and K1 value which is the HARQ-ACK feedback timing information for the PDSCH.

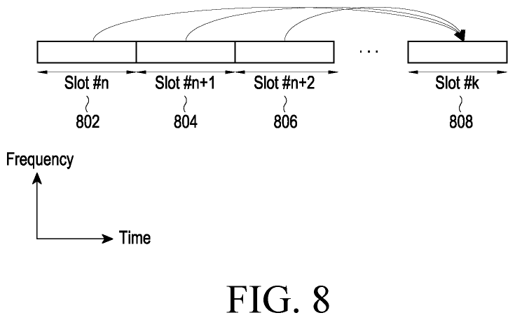

FIG. 8 illustrates a semi-static HARQ-ACK codebook configuration method in an NR system according to an embodiment.

When the number of HARQ-ACK PUCCHs transmittable by the UE in one slot is limited to one, if the UE receives a higher layer signal configuring the semi-static HARQ-ACK codebook, the UE may report HARQ-ACK information for the SPS PDSCH release or receive the PDSCH in the HARQ-ACK codebook in the slot indicated by the value of the PDSCH-to-HARQ feedback timing indicator field included in DCI format 0_1 or DCI format 1_1. The UE may report the HARQ-ACK information bit value, as a NACK, in the HARQ-ACK codebook in the slot not indicated by the PDSCH-to-HARQ feedback timing indicator field in DCI format 1_0 or DCI format 1_1. If the UE reports only HARQ-ACK information for reception of one PDSCH or one SPS PDSCH release in the MA,c cases for reception of candidate PDSCHs, and the reporting is scheduled by DCI format 1_0 including the information in which the counter DACI field is indicated as 1 in the Pcell, the UE may determine one HARQ-ACK codebook for the corresponding PDSCH reception or the corresponding SPS PDSCH release.

Otherwise, an HARQ-ACK codebook determination method according to the following method may be performed.

If the set of PDSCH reception candidates is the MA,c in serving cell c, MA,c may be obtained by pseudo-code 1 steps as follows.

### Pseudo-Code 1 Starts

Step 1: Initialize j to 0 and MA,c to an empty set. Initialize k, the HARQ-ACK transmission timing index, to 0.

Step 2: Set R as a set of rows in the table including PDSCH-mapped slot information, start symbol information, symbol count, or length information. If the PDSCH-possible mapping symbol indicated by each value of R is set as a UL symbol according to the above DL and UL configuration, delete the corresponding row from R.

Step 3-1: Add one to set MA,c if the UE is able to receive one PDSCH for unicast in one slot and R is not an empty set.

Step 3-2: If the UE is able to receive more than one PDSCH for unicast in one slot, count PDSCHs allocable to different symbols in the calculated R and add them to MA,c.

Step 4: Increase k by one and restart from step 2.

### Pseudo-Code 1 Ends

The above-described pseudo-code 1 is described with reference to FIG. 8. To perform HARQ-ACK PUCCH transmission in slot #k 808, the UE may consider all slot candidates capable of PDSCH-to-HARQ-ACK timing that may indicate slot #k 808. In FIG. 8, it is assumed that HARQ-ACK transmission is possible in slot #k 808 by a PDSCH-to-HARQ-ACK timing combination for which only PDSCHs scheduled in slot #n 802, slot #n+1 804, and slot #n+2 806 are possible. The maximum number of PDSCHs schedulable per slot may be derived considering the time domain resource configuration information about the PDSCH schedulable in each of slots 802, 804, and 806 and information indicating whether the symbol in the slot is downlink or uplink. For example, assuming that maximum scheduling is possible for 2 PDSCHs in slot 802, 3 PDSCHs in slot 804, and 2 PDSCHs in slot 806, the maximum number of PDSCHs included in the HARQ-ACK codebook transmitted in slot 808 is 7 in total, which refers to the cardinality of the HARQ-ACK codebook.

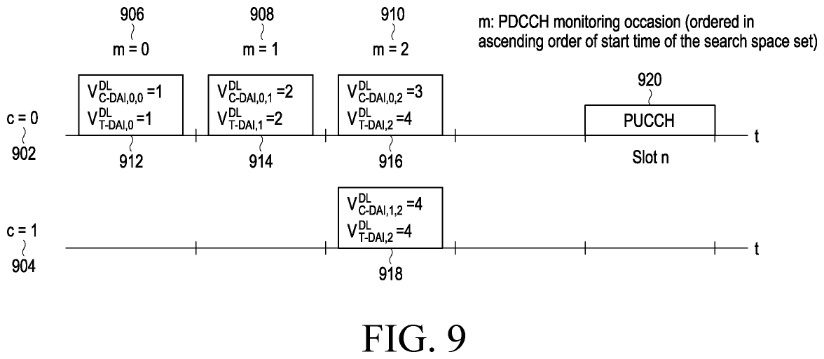

FIG. 9 illustrates a dynamic HARQ-ACK codebook configuration method in an NR system according to an embodiment.

Referring to FIG. 9, the UE may transmit HARQ-ACK information, transmitted in one PUCCH in slot n, based on K0 which is transmission slot position information about the PDSCH scheduled in DCI format 1_0 or 1_1 and the PDSCH-to-HARQ feedback timing value for PUCCH transmission of HARQ-ACK information for SPS PDSCH release or PDSCH reception.

Specifically, for the above-described HARQ-ACK information transmission, the UE may determine the HARQ-ACK codebook of the PUCCH transmitted in the slot determined by K0 and PDSCH-to-HARQ feedback timing based on the DAI included in the DCI indicating SPS PDSCH release or PDSCH.

The DAI includes a counter DAI (cCounter DAI) and a total DAI (tTotal DAI). The counter DAI indicates the position, in the HARQ-ACK codebook, the HARQ-ACK information corresponding to the PDSCH scheduled in DCI format 1_0 or DCI format 1_1. Specifically, the value of counter DAI in DCI format 1_0 or 1_1 indicates the accumulated value of SPS PDSCH release or PDSCH reception scheduled by DCI format 1_0 or DCI format 1_1 in a specific cell c. The above-described accumulated value is set based on the serving cell and the PDCCH monitoring occasion where the scheduled DCI is present.

The total DAI indicates the size of the HARQ-ACK codebook. Specifically, the total DAI value indicates the total number of PDSCH or SPS PDSCH releases scheduled before, including the time (PDCCH monitoring occasion) when the DCI is scheduled. The total DAI is used when the HARQ-ACK information in serving cell c in the CA context also includes HARQ-ACK information for the PDSCH scheduled in another cell including the serving cell c. In other words, the total DAI parameter is not present in a system that operates as one cell.

FIG. 9 illustrates an example UE operation related to the DAI when a dynamic HARQ-ACK codebook is used. FIG. 9 illustrates changes in the values of the counter DAI (C-DAI) and total DAI (T-DAI) indicated by the DCI discovered per PDCCH monitoring occasion set for each carrier when transmitting, on the PUCCH 920, the HARQ-ACK codebook selected based on the DAI in the nth slot of carrier 9 902 when the UE is configured with two carriers c. In the DCI discovered at m=0 (906), C-DAI and T-DAI each indicate a value of 1 (912). In the DCI discovered at m=1 (908), C-DAI and T-DAI each indicate a value of 2 (914). In the DCI discovered for carrier 0 (c=0, 902) of m=2 (910), C-DAI indicates a value of 3 (916). In the DCI discovered for carrier 1 (c=1, 904) of m=2 (910), C-DAI indicates a value of 4 (918). In this case, if carriers 0 and 1 are scheduled on the same monitoring occasion, all T-DAIs are indicated as 4.

In FIGS. 8 and 9, HARQ-ACK codebook determination may operate under the assumption that only one PUCCH containing HARQ-ACK information is transmitted in one slot. In a method in which one PUCCH transmission resource is determined in one slot, when PDSCHs scheduled in different DCIs are multiplexed into one HARQ-ACK codebook and transmitted in the same slot, the PUCCH resource selected for HARQ-ACK transmission may be determined as the PUCCH resource indicated by the PUCCH resource field indicated in the DCI that has last scheduled the PDSCH. In other words, the PUCCH resource indicated by the PUCCH resource field indicated in the DCI scheduled before the above-described DCI is disregarded.

### <Network-Controlled Repeater>

Coverage is one of the important factors in wireless communication systems. Currently, 5G system is commercially available, and so is millimeter wave. However, due to their limited coverage, they are not in wide use. Many operators are seeking ways that are economical and may provide stable coverage.

Integrated access and backhaul (IAB), a technology designed to find a more economical way to enhance stable coverage in wireless communication systems, has been studied in 3GPP Rel-16 and Rel-17. IAB is a type of relay that does not require a wired backhaul network and may relay between the base station and UE. IAB provides similar performance to that of the base station, but use of it may cause an increase in network costs.

Further, conventional RF repeater may be taken into consideration to provide stable coverage in the wireless communication system. The RF repeater is the most basic unit of repeater that amplifies and transmits signals coming from a communication device. RF repeaters have the advantage of reducing network costs because they simply amplify and transmit signals. However, RF repeaters cannot actively respond to various situations that may occur in the network. For example, RF repeaters generally omni-antennas, rather than directional antennas, and thus cannot obtain a beamforming gain. Additionally, even when there is no UE connected to the RF repeater, the RF repeater amplifies noise and transmits the signal, which may cause interference. IAB and RF repeater above have stark advantages and disadvantages, as they are inclined only on either cost or performance. The reality is that increasing coverage in wireless communication systems requires not only performance, but also cost, which is why there is a need for new UEs or amplifiers that take performance and cost both into account.

3GPP Rel-18 is underway for standardization of so-called network-controlled repeater (NCR) that enhances coverage by enabling beamforming technology using adaptive antennas in the RF repeater while maintaining the amplification and transmission operations of the RF repeater. To transmit signals to the UE using adaptive antennas indoors, the NCR should be able to receive control signals from the base station. Therefore, the NCR should be able to detect and decode control signals from the base station and, like the UE, may have a transmission/reception structure for control signals. Basically, the NCR may amplify the signal transmitted from the base station and transmit the amplified signal to the UE, and may amplify the signal from the UE and transmit the amplified signal to the base station. In other words, the NCR may simply amplify and transmit the signals or channels transmitted/received to/from the base station and the UE without detecting and decoding the signals or channels. Therefore, the UE cannot know whether the NCR involves communication between the base station and the UE. In other words, the UE may distinguish between the base station and the NCR and may regard the NCR as a base station. The UE requires no additional or operation for the NCR. Thus, the NCR may support any type of UE.

As described above, the base station may regard the NCR as a regular UE. When the NCR is first installed in the network, the NCR may perform initial access to the base station as does a regular UE, and notify the base station that it is an NCR. After the base station identifies the NCR, and a higher layer connection (e.g., RRC connection) is established between the base station and the UE, the NCR may receive a configuration required for amplification and transmission operations from the base station. The base station need not know whether the UE is connected to the base station directly or via an NCR for controlling purposes. It may be known through various implementations whether the UE served by the base station is within or out of the coverage of the NCR.

The base station may be aware what UE performs communication via what NCR, but the NCR may be unaware what UE performs communication through what NCR. The NCR may perform an operation for amplifying and sending a signal to the UE as controlled by the base station regardless of whether a certain UE is within the coverage of the NCR. The base station may require a dynamic control signal to control the NCR. In the disclosure, this control signal may be referred to as side control information (SCI). The SCI means control information that the base station transmits on a control channel to control the NCR. The SCI may not be recognized by the UE, but may be recognized by the base station and the NCR. For example, the SCI may include a cyclic redundancy check (CRC) scrambled with an NCR-only radio network temporary identifier (RNTI), and the SCI may be transmitted on the PDCCH where the downlink control information (DCI) is transmitted. In the disclosure, the term “SCI” is used for convenience of description, and “SCI” and “DCI” may be interchangeably used.

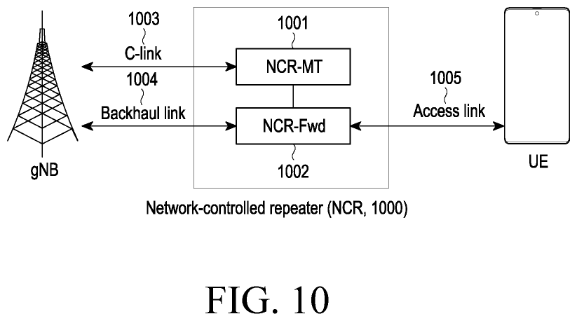

FIG. 10 illustrates an example transmission/reception operation of an NCR when the NCR relays between a base station and a UE according to an embodiment.

Referring to FIG. 10, the NCR 1000 includes a network-controlled repeater-mobile termination (NCR-MT) 1001 capable of transmitting and receiving control signaling of a base station, and a network-controlled repeater-forwarding (NCR-Fwd) 1002 for amplifying and transmitting a downlink signal or amplifying and transmitting an uplink signal according to control signaling of the base station. The NCR-MT 1001 may receive control signaling from the base station through a control link (C-link 1003) and may transmit feedback information to the base station. In other words, the NCR-MT 1001 may appear as a regular terminal to the base station, and the base station may accordingly communicate with the NCR-T 1001. The base station may control the NCR-Fwd 1002 by transmitting control signaling to the NCR-MT 1001. The NCR-Fwd 1002 may process an RF signal and/or the physical layer signal, and may amplify the downlink signal received from the base station and transmit the amplified downlink signal to the UE. In the downlink, the NCR-Fwd 1002 may receive a signal from the base station through the backhaul link 1004 and then transmit the signal to the UE through the access link 1005. In FIG. 10, the backhaul link 1004 and the C-link 1003 are illustrated as individual links but may not necessarily be physically separated links. The NCR 1001 may detect, from the C-link 1003, the SCI configured to control the operation of the NCR 1001 from the base station while simultaneously performing signal amplification and transmission.

The NCR 1001 may receive the uplink signal transmitted by the UE through the access link 1005, amplify the uplink signal, and transfer the amplified uplink signal to the base station through the backhaul link 1004. In this case, the NCR 1001 may transmit uplink feedback or a signal for SCI or higher layer signaling received from the base station to the base station. The backhaul link 1004 may use a wired link or a wireless link. Hereinafter, the NCR may have the same configuration as the example of FIG. 10.

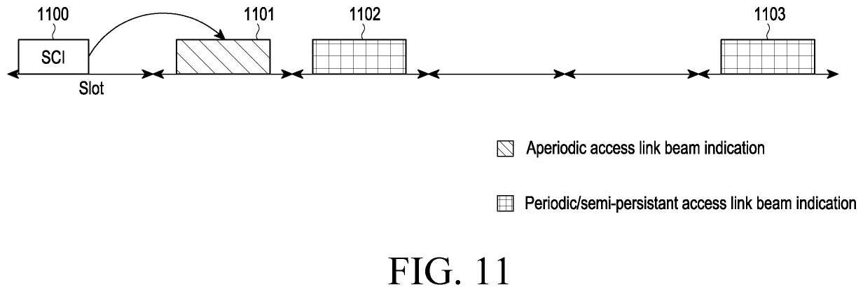

FIG. 11 illustrates an example in which an NCR receives a beam indication for an access link from a base station according to an embodiment.

Referring to FIG. 11, the NCR may periodically/semi-statically/aperiodically receive a beam indication (hereinafter, referred to as an access link beam indication) for the access link from the base station by control signaling such as the SCI 1100. The NCR may aperiodically receive the access link beam indication 1101 from the base station. The NCR may detect and decode the SCI 1100 including the access link beam indication to know the time resource corresponding to the access link beam index. The NCR may perform signal amplification and transmission operations with the indicated time resource and beam index. The NCR may periodically or semi-statically receive the access link beam indications 1102 and 1103 from the base station. FIG. 11 illustrates when an NCR periodically or semi-statically receives an access link beam indication from a base station every predetermined slot period. The NCR may receive higher layer signaling (RRC or MAC-CE) from the base station, and may know the beam index, the time resource, and the period for the access link beam. When the NCR receives the access link beam indication as described above, the NCR performs signal amplification and transmission operations in the indicated access link beam and time resource. The NCR does not perform signal amplification and transmission operations in a period other than the period indicated through the access link beam indication. For example, the NCR-Fwd 1002 performs signal amplification and transmission operations in the slots or symbol sections of reference numerals 1101, 1102, and 1103, but does not perform signal amplification and transmission operations in other slots or symbol sections. The time resource indicated through the access link beam indication may be referred to as a forwarding window. A pair of {access link beam index, time resource} indicated through the access link beam indication may be referred to as a forwarding resource.

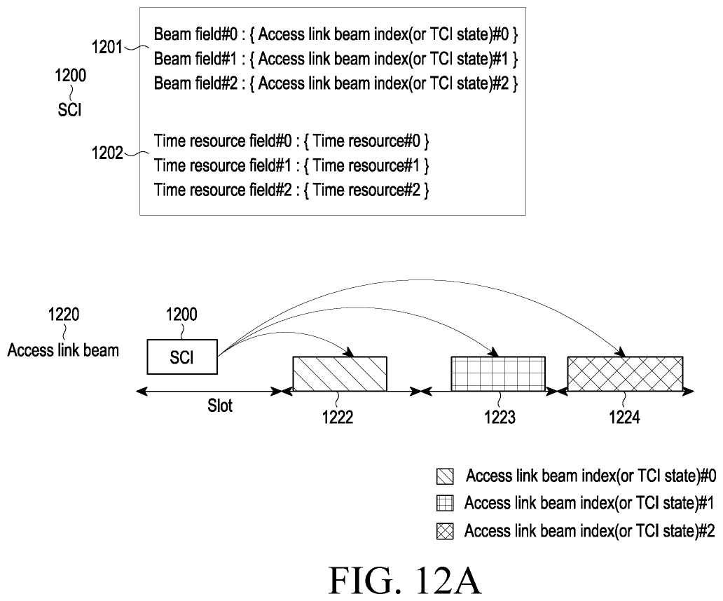

FIG. 12A illustrates an example in which an NCR receives an aperiodic access link beam indication from a base station, and FIG. 12B illustrates an example in which an NCR applies an access link beam in a symbol section in a corresponding slot based on an aperiodic access link beam indication, according to an embodiment.

Referring to FIG. 12A, the NCR may receive an SCI 1200 including an aperiodic access link beam indication for an access link beam 1220 from the base station. The aperiodic access link beam indication may include at least one beam field 1201 and at least one time field 1202 corresponding to the at least one beam field 1201. The beam field 1201 may indicate a beam index of at least one access link beam scheduled to the NCR, and in the at least one time field 1202, each time field may indicate the time resource scheduled to the corresponding access link beam index.

For example, when the NCR receives the SCI 1200 as the DCI scrambled to the NCR-only RNTI, the beam field 1201 may indicate at least one access link beam index, and the time field 1202 may indicate the entry number (e.g., an index) of at least one time resource in the time resource list. The base station may provide the NCR with the time resource list including information about a plurality of time resources in advance through higher layer signaling such as RRC information, and each of the plurality of time resources is mapped to the entry number in the time resource list. In this case, each time resource may include information about at least one of a slot offset, a symbol offset, and a symbol duration.

Referring to FIG. 12B, the slot offset 1211 indicates the offset from a reference slot n+k which is obtained by adding k which is described below to slot n where the NCR receives the SCI 1200 to the slot where the access link beam applies. The slot offset 1211 is information distinct from the slot offset (K₀) value indicating the slot where PDSCH data scheduled through PDCCH is received in the NR standard. The NCR may identify a symbol section where the aperiodic access link beam is applied among symbols in the slot identified based on the slot offset 1211, based on the symbol offset 1212 and the symbol unit interval 1213. Each time resource may include SCS information where the time resource is configured in the scheduled slot. The number of the beam fields 1201 and the number of time fields 1202 are the same, and the number information may be configured/provided to the NCR through higher layer signaling. In FIG. 12A, since the time field 1202 includes three fields, the time field 1202 may indicate three different sections in the time domain (1222, 1223, and 1224). The NCR may apply the access link beam indicated through the SCI 1200 based on at least one of the slot offset, the symbol offset, the symbol unit interval, and the SCS information.

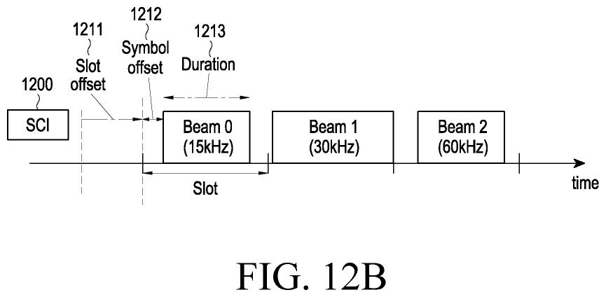

FIG. 13 illustrates an example of an entire offset from a slot when an NCR receives an aperiodic access link beam indication from a base station to a slot when an access link beam is applied according to an embodiment. The entire offset may be understood as an offset considering both the k value and the slot offset.

Referring to FIG. 13, the NCR may detect an SCI 1300 including an aperiodic access link beam indication and identify the slot offset 1310 in the time resource indicated through the aperiodic access link beam indication. The NCR may report to the base station, or be configured by the base station with, a k value set based on at least one of the DCI/SCI decoding time, beam application time, or inter-module switching time, during an NCR capability negotiation process with the base station. The k value may be set based on capability information about the NCR. The DCI/SCI decoding time may indicate, e.g., the time required for the NCR to decode the SCI received through the DCI, and the beam application time may indicate the time required for the NCR to apply the beam according to the aperiodic access link beam indication. The inter-module switching time may indicate the time required to apply the operation of the NCR-Fwd 1002 based on the control information received by the NCR-MT 1001, which is a module in the NCR described with reference to FIG. 10.

Based on the k value, the NCR may identify the access link beam application slot 1313. Specifically, the NCR may determine the n+k slot 1312, which is obtained by adding the k value to slot n 1311 where the SCI 1300 is received, as the reference slot and apply the slot offset 1310 from the reference slot. As a result of applying the slot offset 1310, the NCR may identify an accurate symbol section where the access link beam is to be applied among symbols in the slot 1313 based on the symbol offset and the symbol unit interval described in FIG. 12B in the slot 1313 where the access link beam is applied.

The SCI 1300 detected by the NCR may not explicitly transfer whether the access link beam is applied to the uplink or downlink. In this case, the NCR may determine the direction of the access link beam according to the uplink or downlink indicated by the higher layer signaling tdd-UL-DL-ConfigurationCommon or tdd-UL-DL-ConfigurationDedicated, which may be defined in the 3GPP standard.

### First Embodiment

When the NCR receives an SCI including an aperiodic access link beam indication from the base station, the NCR may determine the n+k slot 1312 obtained by adding k to slot n 1311 where the SCI is received as a reference slot and apply the slot offset 1310 from the reference slot. The operation in which the NCR determines the reference slot may be ambiguous when the SCS of the PDCCH where the SCI is transferred differs from the SCS of the time resource where the access link beam applies. For example, when the SCS of the PDCCH is 15 kHz, and the SCS of the time resource where the access link beam applies is 30 kHz, since two 30 kH slots overlap one 15 kHz slot, the position of reference slot n may be unclear. The k value may also be the same or different for each SCS. Accordingly, the temporal position of the reference slot corresponding to the n+k slot 1312 may differ for each subcarrier.

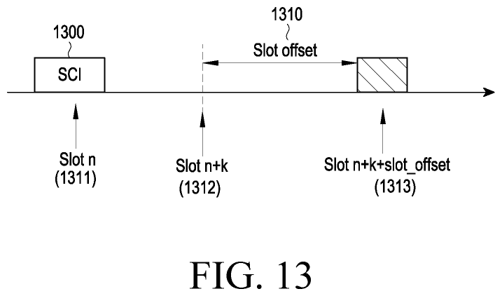

FIG. 14 illustrates an example of an overall offset for each different SCS of an aperiodic access link beam indication that an NCR receives from a base station according to an embodiment. The entire offset may be simply referred to as an offset.

Referring to FIG. 14, the NCR may be aware that the temporal position of the reference slot per SCS, which is shown as, e.g., 15 kHz, 30 kHz, or 60 kHz, differs for each SCS. For convenience of description, it is assumed in FIG. 14 that the slot offsets where the access link beam applies from the reference slot in the 15 kHz, 30 kHz, and 60 kHz SCSs are each 0. The NCR may receive the SCI 1401 in slot n=0 where the 15 kHz SCS is configured, and determine slot 2, which is obtained by adding the k=2 value to slot n=0 where the SCI is received, as the reference slot 1410. In this case, the access link beam 1402 where the 15 kHz SCS having slot offset 0 is configured may be applied to slot 2 according to k=2. The k value may be set/applied differently for each SCS. For example, the access link beam 1403 where the 30 kHz SCS is configured may be configured with k=3 as the k value, and be applied to slot 3. In this case, the reference slot is slot 3, and the access link beam 1403 where the 30 kHz SCS having slot offset 0 is configured may be applied to slot 3. In the same manner, slot n=3 and k=6 where the SCS is received is assumed in the 60 kHz SCS, and the access link beam 1404 where the 60 kHz SCS is configured may be applied to slot 6. In FIG. 14, given the absolute time, the access link beam 1403 and the access link beam 1404 are applied within the time of the reference slot of the 15 kHz SCS. In this regard, since the k value is set based on the NCR capability, such as decoding time/beam application time/inter-module switching time, the NCR may not expect application of the access link beam before the reference slot. If application of the access link beam of the NCR may be applied independently regardless of the reference slots of other SCSs, the access link beam may be applied as in case 1 1400. Independently applicable may indicate that signal amplification and transmission may be processed in parallel or simultaneously in SCSs having different NCR capabilities. If signal amplification and transmission cannot be processed in parallel or simultaneously in the SCSs having different NCR capabilities, the corresponding NCR may not perform independent application as in the example of case 1 1400. For example, the NCR may identify whether the independent application is performed through capability negotiation with the base station.

Unlike in case 1 1400 in FIG. 14, in case 2 1420, the NCR may not independently apply access link beam regardless of the reference slots of other SCSs due to physical factors in the network or hardware limitations (i.e., NCS capability). Since the k value is determined based on, e.g., the decoding time/beam application time/inter-module switching time, if the time required by the decoding time/beam application time/inter-module switching time for each SCS does not elapse, it may be impossible for the NCR to apply the access link beam. For example, in the 15 kHz SCS of case 2 1420 of FIG. 14, the access link beam 1402 may be applied in slot 2 as in case 1 1400. In contrast, the NCR which is not capable of independent application as in case 2 1420 may not apply the access link beam 1404 in the 60 kHz SCS and the access link beam 1403 of case 1 1400 in the 30 kHz SCS before the reference slot of the 15 kHz SCS. In FIG. 14, reference number 1411 indicates a slot to which an access link beam may not be applied according to case 2 1420. In case 2 1420, the NCR may apply the beam, in different SCSs, a predetermined time after receiving the SCI due to hardware limitations or physical factors. The NCR requires that a consistent preparation time be ensured when different SCSs are configured in the time resource.

It is required to clearly define slot n in different SCSs in case 1 1400 and case 2 1420. Slot n may correspond to at least one of 1) to 4) below.
1) First slot overlapping the slot including the PDCCH which includes/transfers the SCI
2) Last slot overlapping the slot including the PDCCH which includes/transfers the SCI
3) First slot overlapping the symbol of the PDCCH which includes/transfers the SCI
4) Last slot overlapping the symbol of the PDCCH which includes/transfers the SCI

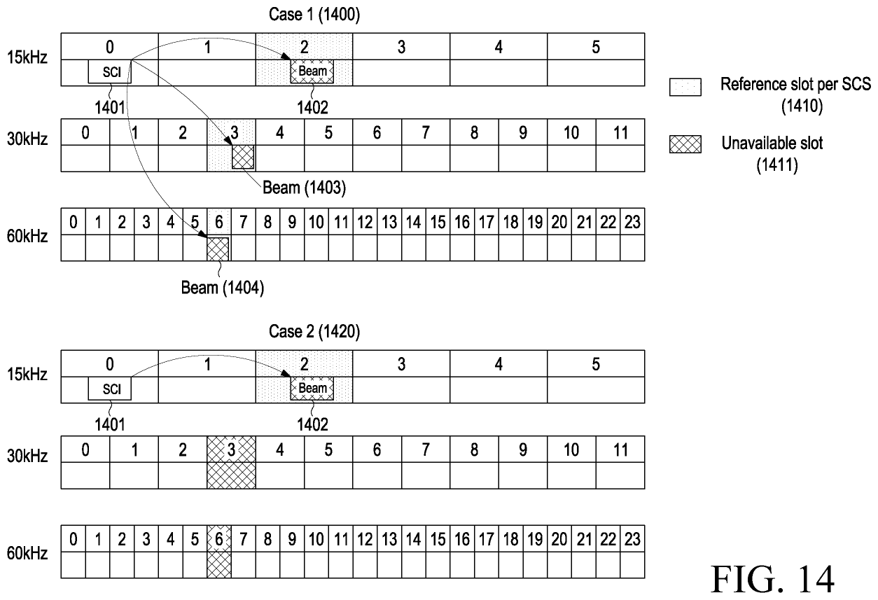

FIG. 15 illustrates an example of ensuring a preparation time of an NCR for applying an access link beam in case 2 of FIG. 14 according to an embodiment.

Referring to FIG. 15, method 1 1500 may use at least one of method 1-1, method 1-2, and method 1-3 below.

Method 1-1: referring to FIG. 15, an example method for ensuring a consistent preparation time between different SCSs in case 2 1420 is to limit scheduling. For example, the NCR may not expect the access link beam to be scheduled before the reference slot 1510 where the SCS of the PDCCH including/transferring the SCI is applied. When method 1-1 applies, the NCR may not expect application of the access link beam in slot 5 where the SCS is 60 KHz.

Method 1-2: or, the NCR may not expect the access link beam to be scheduled before the reference slot where the smallest SCS among at least one SCS configured in at least one time resource indicated by the SCI is applied. When method 1-2 applies, the NCR may not expect application of the access link beam in slot 3 where the SCS is 30 kHz and slots 5, 6, and 7 where the SCS is 60 kHz. In FIG. 15, assuming that the SCI is received in slot 0 where the SCS is 30 kHz and the reference slot is slot 2, slot 3, and slot 5 in the respective slots where the SCS is 15 kHz, 30 kHz, and 60 kHz, according to method 1-2, the NCR may not expect the access link beam to be scheduled before the reference slot (i.e., slot 2) where the lowest 15 kHz SCS among the SCSs configured in the time resource indicated by the SCI is applied. In method 1-2) above, reference numbers 1502, 1503, and 1504 show examples in which the access link beam is scheduled after the reference slot (i.e., slot 2) where the 15 kHz SCS is applied in the slots where the SCS is 15 kHz, 30 kHz, and 60 kHz, respectively.

Method 1-3: or, the NCR may not expect the access link beam to be scheduled before the reference slot where the smallest SCS among the SCSs configured in the time resources included in the time resource list configured by higher layer signaling is applied. When method 1-2 applies, the NCR may not expect application of the access link beam in slot 3 where the SCS is 30 kHz and slots 5, 6, and 7 where the SCS is 60 kHz. In FIG. 15, assuming that the SCI is received in slot 0 where the SCS is 30 kHz and the reference slot is slot 2, slot 3, and slot 5 in the respective slots where the SCS is 15 kHz, 30 kHz, and 60 kHz, according to method 1-2, the NCR may not expect the access link beam to be scheduled before the reference slot (i.e., slot 2) where the lowest 15 kHz SCS is applied among the SCSs configured in the time resources included in the time resource list configured by higher layer signaling. In method 1-2) above, reference numbers 1502, 1503, and 1504 show examples in which the access link beam is scheduled after the reference slot (i.e., slot 2) where the 15 kHz SCS is applied in the slots where the SCS is 15 kHz, 30 kHz, and 60 kHz, respectively.

Another example method for ensuring a consistent preparation time between different SCSs in case 2 1420 of FIG. 14 is to sort the reference slots. The other example is provided as in method 2 1520 of FIG. 15. Method 2 1520 above is a method for determining reference slots of other SCSs with respect to the reference slot of an arbitrary SCS. Specifically, method 2 may include at least one of method 2-1 to method 2-8 below.

Method 2-1: the NCR may determine the first slot overlapping the reference slot (slot n+k) of the SCS of the PDCCH including the SCI as a reference slot. Or, the NCR may determine the slot corresponding to the expression

$$⌊ ( {n}_{PDCCH} + {k}_{PDCCH} ) \frac{{2}^{μ} beam}{{2}^{μ} PDCCH} ⌋$$

as a reference slot. n_{PDCCH} is the slot of the PDCCH containing the SCI, k_{PDCCH} is the k value corresponding to the SCS of the PDCCH (unless varied according to the SCS, the k value is used as it is), and u_{beam} is the SCS of the applied access link beam, and u_{PDCCH} is the SCS of PDCCH. For example, in method 2 1520 of FIG. 15, the reference slot (slot n+k) of the SCS of the PDCCH transferring the SCI is slot 4 where the SCS is 30 kHz, and the first slots (reference slots) overlapping slot 4 where the SCS is 30 kHz in the respective slots where the SCS is 15 kHz and 60 kHz are slot 2 and slot 8 shown in shading. In method 2-1 above, reference numbers 1521, 1522, and 1523 show examples in which in the respective slots where the SCS is 15 kHz, 30 kHz, and 60 kHz, the reference slot is determined with the consistent preparation time determined as above, and the access link beam is scheduled after the reference slot (i.e., slot 2) where the 15 kHz SCS is applied in each slot.

Method 2-2: the NCR may determine the last slot overlapping the reference slot (slot n+k) of the SCS of the PDCCH transferring the SCI as a reference slot. Or, the NCR may determine the slot corresponding to the expression

$$⌈ ( {n}_{PDCCH} + {k}_{PDCCH} + 1 ) \frac{{2}^{μ} beam}{{2}^{μ} PDCCH} ⌉ - 1$$

as a reference slot. n_{PDCCH} is the slot of the PDCCH containing the SCI, k_{PDCCH} is the k value corresponding to the SCS of the PDCCH (unless varied according to the SCS, the k value is used as it is), and u_{beam} is the SCS of the applied access link beam, and u_{PDCCH} is the SCS of PDCCH.

Method 2-3: the NCR may determine the first slot overlapping the reference slot (slot n+k) of the smallest SCS in the time resources indicated by the SCI as a reference slot. Or, the NCR may determine the slot corresponding to the expression

$$⌊ ( {n}_{minSCS} + {k}_{minSCS} ) \frac{{2}^{μ} beam}{{2}^{μ} min SCS} ⌋$$

as a reference slot. n_{minSCS} is slot n corresponding to the smallest SCS among the SCSs configured in the time resource indicated by SCI, k_{minSCS} is the k value corresponding to the lowest SCS among the SCSs configured in the time resource indicated by SCI (unless varied according to the SCS, the k value is used as it is), u_{beam} is the SCS of the applied access link beam, and u_{minSCS} is the smallest SCS among the SCSs configured in the time resource indicated by the SCI. For example, in FIG. 15, the reference slot (slot n+k) of the smallest SCS in the time resource indicated by the SCI is slot 2 where the SCS is 15 kHz, and the first slots (reference slots) overlapping slot 2 where the SCS is 15 kHz in SCS 30 kHz and 60 kHz are slot 4 and slot 8 shown in shading. In method 2-3 above, reference numbers 1521, 1522, and 1523 show examples in which in SCS 15 kHz, 30 kHz, and 60 kHz, the reference slot is determined with the consistent preparation time determined as above, and the access link beam is scheduled after the reference slot (i.e., slot 2) where the 15 kHz SCS is applied.

Method 2-4: the NCR may determine the last slot overlapping the reference slot (slot n+k) of the smallest SCS in the time resources indicated by the SCI as a reference slot. Or, the NCR may determine the slot corresponding to the expression

$$⌈ ( {n}_{minSCS} + {k}_{minSCS} + 1 ) \frac{{2}^{μ} beam}{{2}^{μ} min SCS} ⌉ - 1$$

as a reference slot. n_{minSCS} is slot n corresponding to the lowest SCS among the SCSs configured in the time resource indicated by SCI, k_{minSCS} is the k value corresponding to the lowest SCS among the SCSs configured in the time resource indicated by SCI (unless varied according to the SCS, the k value is used as it is), u_{beam} is the SCS of the applied access link beam, and u_{minSCS} is the lowest SCS among the SCSs configured in the time resource indicated by the SCI.

Method 2-5: Method 2-3 may not be aware of the reference slot before decoding the SCI. To be aware of the reference slot before decoding the SCI, the NCR may determine the first slot overlapping the reference slot (slot n+k) of the lowest SCS in the time resources included in the time resource list configured by higher layer signaling, as a reference slot. Or, the NCR may determine the slot corresponding to the expression

$$⌊ ( {n}_{minSCS} + {k}_{minSCS} ) \frac{{2}^{μ} beam}{{2}^{μ} min SCS} ⌋$$

as a reference slot. n_{minSCS} is slot n corresponding to the lowest SCS in the time resources included in the time resource list configured by higher layer signaling, k_{minSCS} is the k value corresponding to the lowest SCS in the time resources included in the time resource list configured by higher layer signaling (unless varied according to the SCS, the k value is used as it is), u_{beam} is the SCS of the applied access link beam, and u_{minSCS} is the lowest SCS in the time resources included in the time resource list configured by higher layer signaling.

Method 2-6: Method 2-3 may not be aware of the reference slot before decoding the SCI. To be aware of the reference slot before decoding the SCI, the NCR may determine the first slot overlapping the reference slot (slot n+k) of the lowest SCS in the time resources included in the time resource list configured by higher layer signaling and the PDCCH transferring the SCI, as a reference slot. Or, the NCR may determine the slot corresponding to the expression

$$⌊ ( {n}_{minSCS} + {k}_{minSCS} ) \frac{{2}^{μ} beam}{{2}^{μ} min SCS} ⌋$$

as a reference slot. n_{minSCS} is slot n corresponding to the lowest SCS in the time resources included in the time resource list configured by higher layer signaling and the PDCCH transferring the SCI, k_{minSCS} is the k value corresponding to the lowest SCS in the time resources included in the time resource list configured by higher layer signaling and the PDCCH including the SCI (unless varied according to the SCS, the k value is used as it is), u_{beam} is the SCS of the applied access link beam, and u_{minSCS} is the lowest SCS in the time resources included in the time resource list configured by higher layer signaling and the PDCCH including the SCI.

Method 2-7: Method 2-4 may not be aware of the reference slot before decoding the SCI. To be aware of such, the NCR may determine the last slot overlapping the reference slot (slot n+k) of the lowest SCS in the time resources included in the time resource list configured by higher layer signaling, as a reference slot. Alternatively, the NCR may determine the slot corresponding to the expression

$$⌈ ( {n}_{minSCS} + {k}_{minSCS} + 1 ) \frac{{2}^{μ} beam}{{2}^{μ} minSCS} ⌉ - 1$$

as a reference slot. n_{minSCS} is slot n corresponding to the lowest SCS in the time resources included in the time resource list configured by higher layer signaling, k_{minSCS} is the k value corresponding to the lowest SCS in the time resources included in the time resource list configured by higher layer signaling (unless varied according to the SCS, the k value is used as it is), u_{beam} is the SCS of the applied access link beam, and u_{minSCS} is the lowest SCS in the time resources included in the time resource list configured by higher layer signaling.

Method 2-8: Method 2-4 may not be aware of the reference slot before decoding the SCI. To be aware of such, the NCR may determine the last slot overlapping the reference slot (slot n+k) of the lowest SCS in the time resources included in the time resource list configured by higher layer signaling and the PDCCH including the SCI, as a reference slot. Alternatively, the NCR may determine the slot corresponding to the expression

$$⌈ ( {n}_{minSCS} + {k}_{minSCS} + 1 ) \frac{{2}^{μ} beam}{{2}^{μ} min SCS} ⌉ - 1$$

as a reference slot. n_{minSCS} is slot n corresponding to the lowest SCS in the time resources included in the time resource list configured by higher layer signaling and the PDCCH including the SCI, k_{minSCS} is the k value corresponding to the lowest SCS in the time resources included in the time resource list configured by higher layer signaling and the PDCCH including the SCI (unless varied according to the SCS, the k value is used as it is), u_{beam} is the SCS of the applied access link beam, and u_{minSCS} is the lowest SCS in the time resources included in the time resource list configured by higher layer signaling and the PDCCH including the SCI.

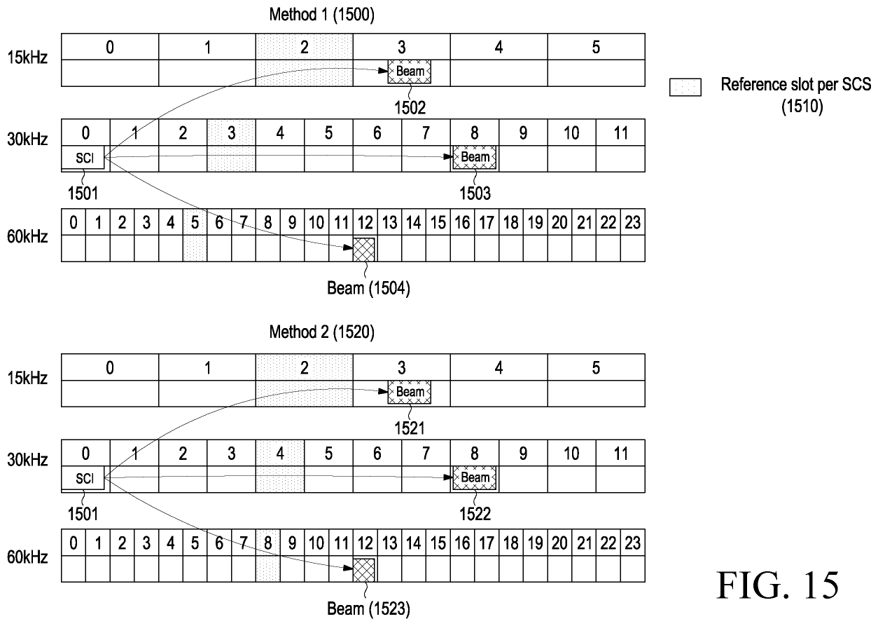

FIG. 16 illustrates a method in which an NCR determines an overall offset of an access link beam in a wireless communication system according to an embodiment.

Referring to FIG. 16, in step 1601, the NCR may detect an SCI scrambled with an NCR-specific RNTI in a downlink control channel. The SCI may include an aperiodic access link beam indication, and the aperiodic access link beam indication may include at least one beam field and at least one time field (time information) corresponding to the at least one beam field (beam information). The beam field (beam information) may indicate a beam index of at least one access link beam scheduled to the NCR, and in the at least one time field, each time may indicate the time resource scheduled to the corresponding access link beam index. The base station may provide the NCR with information about a plurality of time resources in advance through higher layer signaling such as RRC information, and each of the plurality of time resources is mapped to the entry number. Each time resource may include information about at least one of a slot offset, a symbol offset, and a symbol duration. Further, each time resource may include SCS information where the time resource is configured in the scheduled slot.

In step 1602, in the detected SCI, the NCR may determine/identify a reference slot for each SCS. In step 1602, the NCR may determine/identify the reference slot for each SCS having different SCSs using the above-described method 1 or method 2. The NCR may report to the base station, or be configured from the base station, through higher layer signaling such as RRC information, with, a k value set based on at least one of the DCI/SCI decoding time, beam application time, or inter-module switching time, during an NCR capability negotiation process with the base station. The k value may be set based on capability information about the NCR. The slot offset indicates the offset from a reference slot n+k which is obtained by adding k to slot n where the NCR receives the SCI to the slot where the access link beam applies.

In step 1602, the NCR may determine the first slot overlapping the reference slot (slot n+k) of the SCS of the PDCCH including the SCI as a reference slot. Alternatively, the NCR may determine the last slot overlapping the reference slot (slot n+k) of the SCS of the PDCCH transferring the SCI as a reference slot. Alternatively, the NCR may determine the first slot overlapping the reference slot (slot n+k) of the lowest SCS in the time resources indicated by the SCI as a reference slot. Alternatively, the NCR may determine the last slot overlapping the reference slot (slot n+k) of the lowest SCS in the time resources indicated by the SCI as a reference slot. Alternatively, the NCR may determine the first slot overlapping the reference slot (slot n+k) of the lowest SCS among the SCSs in the time resources included in the time resource list, as a reference slot. Alternatively, the NCR may determine the last slot overlapping the reference slot (slot n+k) of the lowest SCS among the SCSs in the tie resources included in the time resource list as a reference slot. Alternatively, the NCR may determine the first slot overlapping the reference slot (slot n+k) of the lowest SCS among the SCSs of the PDCCH including the SCI and the SCSs in the time resources included in the time resource list as a reference slot. Alternatively, the NCR may determine the last slot overlapping the reference slot (slot n+k) of the lowest SCS among the SCSs of the PDCCH including the SCI and the SCSs in the time resources included in the time resource list as a reference slot. Alternatively, the NCR may not expect the access link beam to be scheduled in other SCSs before the reference slot where the lowest SCS among the SCSs configured in the time resource indicated by the SCI is applied. Alternatively, the NCR may not expect the access link beam to be scheduled in other SCSs before the reference slot where the lowest SCS among the SCSs configured in the time resources included in the time resource list is applied. Alternatively, the NCR may apply the access link beam for each SCS, independently regardless of the reference slot in different SCSs in applying the access link beam.

After determining/identifying the reference slot, in step 1603, the NCR may perform access link beam application. The NCR may identify a symbol section where the aperiodic access link beam is applied among symbols in the slot identified based on the slot offset, based on the symbol offset and the symbol unit interval.

### Second Embodiment

When the NCR receives the aperiodic access link beam indication through the SCI, the slot offset value included in the time resource indicated by the NCR may be up to 14. In other words, the NCR may apply the access link beam according to the access link beam indication from the reference slot to up to 14 slots. The maximum 14 slots may include slots using SCS with each other. However, if all SCSs share the same value as the maximum value of the slot offset, the absolute time for scheduling for each SCS may be reduced. The second embodiment provides a solution to this situation. A slot where the SCS is A kHz will be referred to as an A kHz slot.

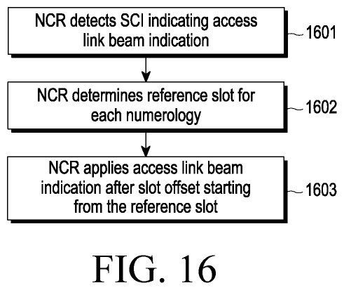

FIG. 17 illustrates an example of when an NCR uses the same maximum slot offset for slots using different SCSs according to an embodiment.

Referring to FIG. 17, the NCR may receive an access link beam having a slot offset for a 15 kHz SCS of 1, 2, 5, 6, and 13 and an access link beam having a slot offset for a 30 kHz SCS of 6, 7, 8, and 14 in one SCI 1701. When the maximum slot offset is 14, the slot offset exceeding 14 may not be set in the 30 kHz SCS, and thus the corresponding slots (slots 15 to 29) may be viewed as slots 1711 where the aperiodic access link beam may not be scheduled. In this case, in slots where the slot offset is less than 14 at SCS 60 kHz, all other SCSs already occupy the time resource, and thus scheduling may not be possible. Since the slot offset at SCS 60 kHz may not be greater than 14, an additional SCI indication is required to schedule the aperiodic access link beam at SCS 60 kHz. As shown in FIG. 17, when all of the different SCSs share the same slot offset, there may be a limitation in indicating the access link beam.

A method to address the above-described problem may be setting a slot offset with a fixed reference for each SCS (method 3). Method 3 may use at least one of method 3-1 to method 3-4 below.

Method 3-1: A slot offset may be set for each SCS. For example, the maximum slot offset of SCS 15 kHz is defined as 14, and the maximum slot offset of SCS higher than SCS 15 kHz may be increased in proportion to the SCS. For example, the maximum slot offset of SCS 15 kHz may have a value of 14, the maximum slot offset of SCS 30 kHz may have a value of 28, the maximum slot offset of SCS 60 kHz may have a value of 56, and the maximum slot offset of SCS 120 kHz may have a value of 112.

Method 3-2: The slot offset reference of each SCS may be set to a slot offset of SCS 15 kHz. For example, when the slot offset of the NCR is set to 14 through the SCI and is indicated as a 30 kHz SCS, the first or last slot among the slots of SCS 30 kHz (hereinafter referred to as 30 kHz slots) overlapping the slots of SCS 15 kHz (hereinafter referred to as 15 kHz slots) may be identified as where the access link beam is applied.

Method 3-3: Since method 3-2 uses only the first or last slot among the slots overlapping the 15 kHz slot, scheduling may be limited. If there is an additional setting, the scheduling limitation may be mitigated. For example, if the additional setting value of the slot offset is 0, the slot where the access link beam is applied may be identified as the first slot among slots overlapping the 15 kHz slot, and if it is 1, it may be identified as the second slot among the slots overlapping the SCS 15 kHz.

Method 3-4: Since method 3-2 uses only the first or last slot among the slots overlapping SCS 15 kHz, scheduling may be limited. In this case, the scheduling limitation may be mitigated by a repetition setting. The NCR may repeat the access link beam indication in all slots overlapping SCS 15 kHz. For example, the access link beam indication time resource applied in the first slot overlapping the SCS 15 kHz slot may be repeated until the last slot.

Another method for resolving the limitation in indicating the access link beam may be differently interpreting the slot offset of the SCS according to the criteria (method 4). Specifically, method 4 above may use at least one of method 4-1 to method 4-7 below.

Method 4-1: A slot offset may be set based on the lowest SCS among the set SCSs. For example, if the lowest SCS among the SCSs included in the time resource indicated by the NCR through the SCI is 30 kHz, the NCR may identify that the first or last slot among the slots of other SCSs overlapping the slot of 30 kHz is a slot where the access link beam is applied.

Method 4-2: Method 4-1 uses only the first or last slot among the slots of other SCSs where the lowest SCS among the configured SCSs overlaps the set slot, and thus scheduling may be limited. If there is an additional setting to the slot offset here, the scheduling limitation may be mitigated. For example, if the additional setting value of the slot offset is 0, the slot where the access link beam is applied may be appreciated as the first slot among slots overlapping the 15 kHz slot, and if it is 1, it may be appreciated as the second slot.

Method 4-3: Method 4-1 uses only the first or last slot among the slots overlapping the slot where the lowest SCS among the configured SCSs is configured, as a slot where the access link beam is applied, and thus scheduling may be limited. In this case, the scheduling limitation may be mitigated by a repetition setting. The NCR may repeat the access link beam indication in all slots overlapping the slot where the lowest SCS is configured. For example, the time resource according to the access link beam indication applied in the first slot overlapping the 15 kHz slot may be repeated until the last slot.

Method 4-4: A slot offset may be identified based on the SCS of the PDCCH transferring the SCI. For example, if the SCS of the PDCCH transferring the SCI indicated to the NCR is 30 kHz, the first or last slot overlapping the 30 kHz slot may be known as a slot where the access link beam is applied.

Method 4-5: Method 4-4 uses only the first or last slot among the slots overlapping the slot where the PDCCH transferring the SCI is received, as a slot where the access link beam is applied, and thus scheduling may be limited. If there is an additional setting here, the scheduling limitation may be mitigated. For example, if the additional setting value of the slot offset is 0, the slot where the access link beam is applied may be appreciated as the first slot among slots overlapping the 15 kHz slot. If the slot offset is 1, it may be appreciated as the second slot.

Method 4-6: Method 4-4 uses only the first or last slot among the slots overlapping the slot where the PDCCH transferring the SCI is received, as a slot where the access link beam is applied, and thus scheduling may be limited. In this case, the scheduling limitation may be mitigated by a repetition setting. The NCR may repeat the access link beam indication in all overlapping slots. For example, the access link beam indication time resource applied in the first slot among the slots overlapping the 15 kHz slot may be repeated until the last slot.

Method 4-7: The access link beam indication may be repeated every predetermined period within the search period of the PDCCH where the SCI is transferred. For example, it is assumed that the search period of the PDCCH where the SCI is transferred is 30 slots, the SCS is 15 kHz, and the access link beam indication is repeated every 14 slots. In this case, the 15 kHz slot may repeat the access link beam indication twice, and the 30 kHz slot may repeat the access link beam indication four times. The repetition may indicate that the time resource indicated up to the 14th slot is repeated using only the slot offset as the reference slot.

### Third Embodiment

When the NCR receives the aperiodic access link beam indication through the SCI, the NCR may receive the time resource indication through different fields in the SCI. The number of time resource fields may be set to higher layer signaling, and each time resource field may indicate an entry of list information including information about a plurality of time resources. The entry refers to an entry number (e.g., an index) of the time resource corresponding to the access link beam index illustrated in FIG. 12A, and the list information may be provided to the NCR through higher layer signaling such as RRC information. Therefore, the bit width of the time resource field may vary according to the number of entries. In this case, when the time resources indicated in different fields overlap in the same symbol, and when the access link beams respectively corresponding to the fields are different from each other, the operation of the NCR may become ambiguous.

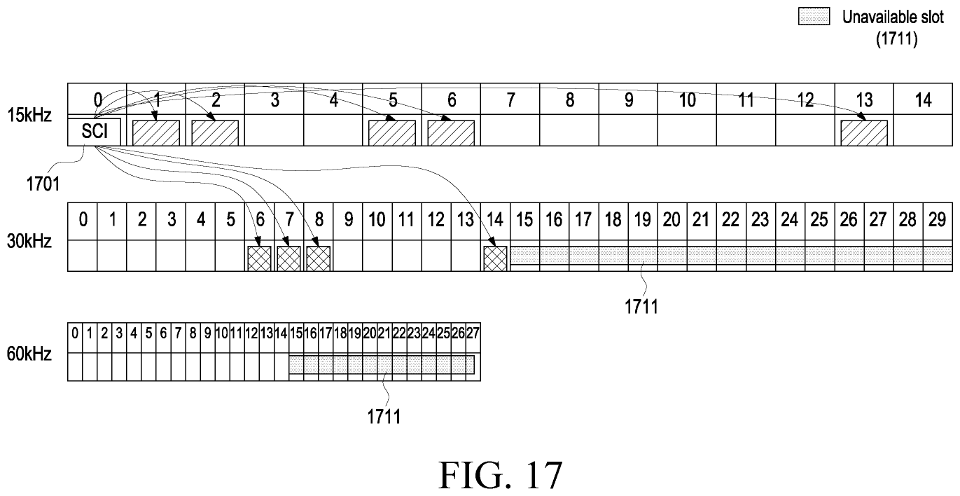

FIG. 18 illustrates an example in which different time resources of an NCR overlap in the same symbol according to an embodiment.

Referring to FIG. 18, the NCR receives an access link beam through at least one time resource field 1802, 1803, and 1804 and at least one access link beam index field 1801 in the SCI 1800. The NCR may be instructed to apply the access link beam over slots 1 and 2 through the first time resource field 1802, to apply the access link beam over slot 2 through the second time resource field 1803, and to apply the access link beam over slots 2, 3, and 4 in the third time resource field 1804. In this case, in the NCR, different access link beam applications overlap in at least one symbol in slot 2, as shown in reference numeral 1810. In this case, since an agreed-on operation is not defined, the NCR may arbitrarily select the application of the access link beam, and the selection may not match the access link beam indication intended by the base station. To prevent such a situation, the NCR may not expect different time resources corresponding to different access link beams to overlap in the same symbol. However, to increase scheduling flexibility within a limited number of time resource fields, it is necessary to apply an access link beam according to priority when an overlap occurs. As shown in reference number 1820, if the access link beam is applied in such a manner that different time resources do not overlap in the same symbol depending on priority, the access link beam is changed four times, but an indication for stable access link beam application is possible through three time resource fields.

If the NCR is configured in relation to SCI time resource priority by higher layer signaling (e.g., RRC or MAC-CE), the time resource field priority may be designated based on the order of the time resource fields, SCS, or slot offset. For example, the time resource fields may take priority in ascending or descending order of time resource field index. As another example, the priority of the time resource fields may be determined in such a manner that the time resource field having the largest SCS has the highest priority, and the time resource field having the next largest SCS has next. As another example, the time resource field with the larger slot offset included in the time resource may be prioritized. If the slot offsets are the same, the symbol offsets may be compared, so that the time resource field having the larger symbol offset is prioritized. An additional field in the SCI may indicate which time resource takes priority. The above-described examples for determining priority are not mutually exclusive, but may be operated in combination.

As such, the NCR may clearly recognize the reference slot in the time domain based on the indication information provided through the SCI and stably perform amplification and transmission operations at an indicated time under the control of the base station in the wireless communication system.

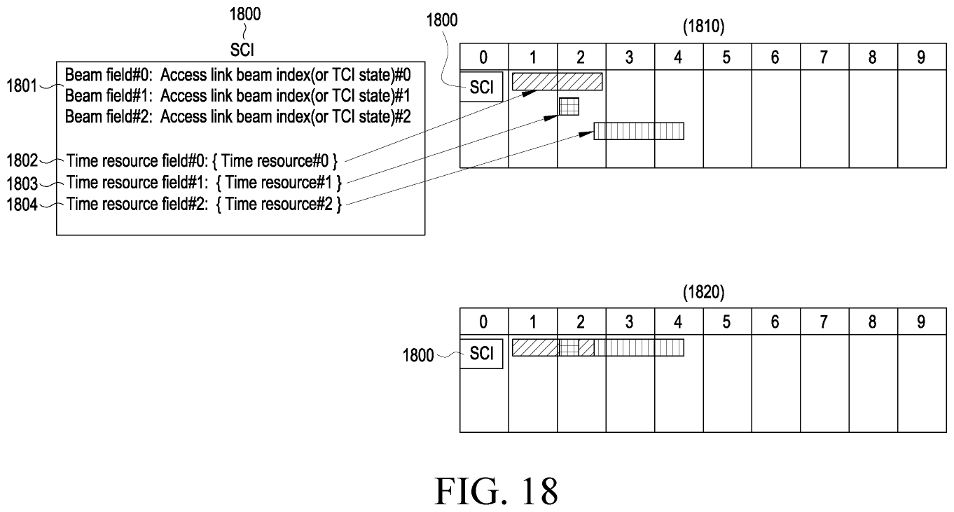

FIG. 19 illustrates a structure of a UE in a wireless communication system according to an embodiment.

Referring to FIG. 19, a UE may include a UE receiver 1905, a UE transmitter 1910, and a UE processor (controller) 1900.

For example, the NCR relaying between the UE and the base station is recognized as a UE by the base station. Thus, in this case, the UE of FIG. 19 may be an NCR. For example, the NCR may include a receiver, a transmitter, and a processor (controller). The receiver, transmitter, and processor (controller) correspond to the UE receiver 1905, the UE transmitter 1910, and the UE processor (controller) 1900 in FIG. 19.

The UE receiver 1905 and the UE transmitter 1910 may be collectively referred to as a transceiver. According to the above-described UE communication method, the UE receiver 1905, the UE transmitter 1910, and the UE processor 1900 of the UE may be operated. However, the components of the UE are not limited thereto. For example, the UE may include more components (e.g., a memory) or fewer components than the above-described components. The UE receiver 1905, the UE transmitter 1910, and the UE processor 1900 may be implemented in the form of a single chip.

The UE receiver 1905 and the UE transmitter 1910 (or transceiver) may transmit/receive signals to/from the base station. The signal may include control information and data. To that end, the transceiver may include a radio frequency (RF) transmitter for frequency-up converting and amplifying signals transmitted and an RF receiver for low-noise amplifying signals received and frequency-down converting the frequency of the received signals. However, this is merely an example of the transceiver, and the components of the transceiver are not limited to the RF transmitter and the RF receiver. The UE receiver 1905 and the UE transmitter 1910 (or transceiver) may include a communication interface for transmission/reception with the base station through a wired or wireless backhaul link.

The transceiver may receive a signal through a radio channel (or wired/wireless backhaul link) and output it to the UE processor 1900 and transmit a signal output from the UE processor 1900 through the radio channel (or wired/wireless backhaul link). The transceiver 1110 may be referred to as a transmission/reception unit.

The memory may store programs and data necessary for the operation of the UE. The memory may store control information or data that is included in the signal obtained by the UE. The memory may include a storage medium, such as a read only memory (ROM), a random access memory (RAM), hard disk, compact disc (CD)-ROM, and digital versatile disc (DVD), or a combination of storage media.

The UE processor 1900 may control a series of processes for the UE to operate according to the above-described embodiments. The UE processor 1900 may be implemented as a controller or one or more processors.

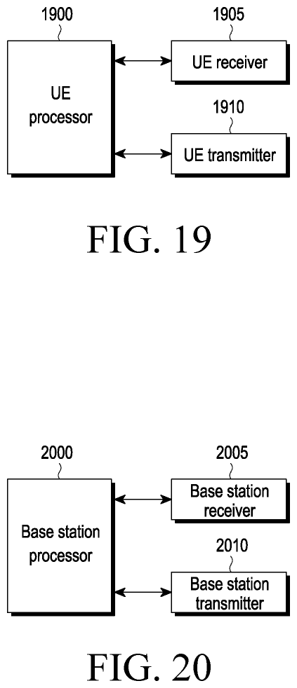

FIG. 20 illustrates a structure of a base station in a wireless communication system according to an embodiment.

Referring to FIG. 20, a base station may include a base station receiver 2005, a base station transmitter 2010, and a base station processor (controller) 2000.

For example, as described above, the NCR relaying between the UE and the base station is recognized as a base station by the UE. Thus, in this case, the base station of FIG. 20 may be an NCR. For example, the NCR may include a receiver, a transmitter, and a processor (controller).

The base station receiver 2005 and the base station transmitter 2010 may be collectively referred to as a transceiver. According to the above-described base station communication method, the base station receiver 2005, the base station transmitter 2010, and the base station processor 2000 of the base station may be operated. However, the components of the base station are not limited thereto. For example, the base station may include more components (e.g., a memory) or fewer components than the above-described components. The base station receiver 2005, the base station transmitter 2010, and the base station processor 2000 may be implemented in the form of a single chip.

The base station receiver 2005 and the base station transmitter 2010 (or transceiver) may transmit/receive signals to/from the UE. The signal may include control information and data. To that end, the transceiver may include a radio frequency (RF) transmitter for frequency-up converting and amplifying signals transmitted and an RF receiver for low-noise amplifying signals received and frequency-down converting the frequency of the received signals. However, this is merely an example of the transceiver, and the components of the transceiver are not limited to the RF transmitter and the RF receiver. The base station receiver 2005 and the base station transmitter 2010 (or transceiver) may include a communication interface for transmission/reception with the NCR through a wired or wireless backhaul link.

The transceiver may receive a signal through a radio channel (or wired/wireless backhaul link) and output it to the base station processor 2000 and transmit a signal output from the base station processor 2000 through the radio channel (or wired/wireless backhaul link). The transceiver 1110 may be referred to as a transmission/reception unit.

The memory may store programs and data necessary for the operation of the base station. The memory may store control information or data that is included in the signal obtained by the base station. The memory may include a storage medium, such as ROM, RAM, hard disk, CD-ROM, and DVD, or a combination of storage media.

The base station processor 2000 may control a series of processes for the base station to operate according to the above-described embodiments. The base station processor 2000 may be implemented as a controller or one or more processors.

The blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate indicates for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction indicates for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Each block may represent a module, segment, or part of a code including one or more executable instructions for executing a specified logical function(s). Further, in some replacement embodiments, the functions mentioned in the blocks may occur in different orders. For example, two blocks that are consecutively shown may be performed substantially simultaneously or in reverse order depending on corresponding functions.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a network-controlled repeater (NCR) for amplifying and forwarding a signal to a user equipment (UE) in a wireless communication system, the method comprising:
receiving, from a base station, configuration information including information on time resources associated with an access link between the NCR and the UE, wherein information on at least one time resource among the information on the time resources further includes information on at least one first slot offset for the at least one time resource;
transmitting, to the base station, capability information including information indicating a value of a second slot offset for a reference slot;
receiving, from the base station, downlink control information (DCI) on a physical downlink control channel (PDCCH) in a first slot, the DCI including information on at least one beam and information on the at least one time resource corresponding to the at least one beam;
identifying the reference slot associated with the at least one time resource, based on the first slot and the value of the second slot offset;
identifying at least one second slot for the at least one time resource, based on the reference slot and the at least one first slot offset, wherein the at least one time resource starts at the at least one second slot that is offset by the at least one first slot offset from the reference slot; and
transmitting the signal to the UE by using the at least one beam and the at least one time resource corresponding to the at least one beam.

2. The method of claim 1,
wherein the reference slot starts no earlier than the first slot in which the DCI is received, and
wherein the reference slot is identified based on a subcarrier spacing (SCS) of the first slot and the second slot offset for the reference slot.

3. The method of claim 1,
wherein the configuration information further includes beam index related information associated with the time resources.

4. The method of claim 1,
wherein the at least one beam for the access link is an aperiodic access link beam.

5. The method of claim 1,
wherein the information on the at least one time resource further includes at least one of a symbol offset or a symbol duration.

6. A network-controlled repeater (NCR) for amplifying and forwarding a signal to a user equipment (UE) in a wireless communication system, the NCR comprising:
a transceiver; and
a processor configured to:
receive, via the transceiver from a base station, configuration information including information on time resources associated with an access link between the NCR and the UE, wherein information on at least one time resource among the information on the time resources further includes information on at least one first slot offset for the at least one time resource,
transmit, to the base station via the transceiver, capability information including information indicating a value of a second slot offset for a reference slot,
receive, via the transceiver from the base station, downlink control information (DCI) on a physical downlink control channel (PDCCH) in a first slot, the DCI including information on at least one beam and information on the at least one time resource corresponding to the at least one beam,
identify the reference slot associated with the at least one time resource, based on the first slot and the value of the second slot offset,
identify at least one second slot for the at least one time resource, based on the reference slot and the at least one first slot offset, wherein the at least one time resource starts at the at least one second slot that is offset by the at least one first slot offset from the reference slot, and
transmit, to the UE via the transceiver, the signal by using the at least one beam and the at least one time resource corresponding to the at least one beam.

7. The NCR of claim 6,
wherein the reference slot starts no earlier than the first slot in which the DCI is received, and
wherein the reference slot is identified based on a subcarrier spacing (SCS) of the first slot and the second slot offset for the reference slot.

8. The NCR of claim 6,
wherein the configuration information further includes beam index related information associated with the time resources.

9. The NCR of claim 6,
wherein the at least one beam for the access link is an aperiodic access link beam.

10. The NCR of claim 6,
wherein the information on the at least one time resource further includes at least one of a symbol offset or a symbol duration.

11. A method performed by a base station using a network-controlled repeater (NCR) for amplifying and forwarding a signal to a user equipment (UE) in a wireless communication system, the method comprising:
transmitting, to the NCR, configuration information including information on time resources associated with an access link between the NCR and the UE, wherein information on at least one time resource among the information on the time resources further includes information on at least one first slot offset for the at least one time resource;
receiving, from the NCR, capability information including information indicating a value of a second slot offset for a reference slot;
transmitting, to the NCR, downlink control information (DCI) on a physical downlink control channel (PDCCH) in a first slot, the DCI including information on at least one beam and information on the at least one time resource corresponding to the at least one beam;
identifying the reference slot associated with the at least one time resource, based on the first slot and the value of the second slot offset;
identifying at least one second slot for the at least one time resource, based on the reference slot and the at least one first slot offset, wherein the at least one time resource starts at the at least one second slot that is offset by the at least one first slot offset from the reference slot; and
transmitting the signal to the UE through the NCR using the at least one beam and the at least one time resource corresponding to the at least one beam.

12. The method of claim 11,
wherein the reference slot starts no earlier than the first slot in which the DCI is received, and
wherein the reference slot is identified based on a subcarrier spacing (SCS) of the first slot and the second slot offset for the reference slot.

13. The method of claim 11,
wherein the configuration information further includes beam index related information associated with the time resources.

14. The method of claim 11,
wherein the at least one beam for the access link is an aperiodic access link beam.

15. The method of claim 11,
wherein the information on the at least one time resource further includes at least one of a symbol offset or a symbol duration.

16. A base station using a network-controlled repeater (NCR) for amplifying and forwarding a signal to a user equipment (UE) in a wireless communication system, the base station comprising:
a transceiver; and
a processor configured to:
transmit, to the NCR via the transceiver, configuration information including information on time resources associated with an access link between the NCR and the UE, wherein information on at least one time resource among the information on the time resources further includes information on at least one first slot offset for the at least one time resource,
receive, via the transceiver from the NCR, capability information including information indicating a value of a second slot offset for a reference slot,
transmit, to the NCR via the transceiver, downlink control information (DCI) on a physical downlink control channel (PDCCH) in a first slot, the DCI including information on at least one beam and information on the at least one time resource corresponding to the at least one beam,
identify the reference slot associated with the at least one time resource, based on the first slot and the value of the second slot offset,
identify at least one second slot for the at least one time resource, based on the reference slot and the at least one first slot offset, wherein the at least one time resource starts at the at least one second slot that is offset by the at least one first slot offset from the reference slot, and
transmit, via the transceiver, the signal to the UE through the NCR using the at least one beam and the at least one time resource corresponding to the at least one beam.

17. The base station of claim 16,
wherein the reference slot starts no earlier than the first slot in which the DCI is received, and
wherein the reference slot is identified based on a subcarrier spacing (SCS) of the first slot and the second slot offset for the reference slot.

18. The base station of claim 16,
wherein the configuration information further includes beam index related information associated with the time resources.

19. The base station of claim 16,
wherein the at least one beam for the access link is an aperiodic access link beam.

20. The base station of claim 16,
wherein the information on the at least one time resource further includes at least one of a symbol offset or a symbol duration.
